(19) United States
(12) Patent Application Publication
(10) Pub. No.: US 2017/0206501 A1
(43) Pub. Date: Jul. 20, 2017

(54) Work Collaboration System with Hierarchical Views, Media Sharing, and Messaging

(71) Applicant: Tso Jen Wang, Irvine, CA (US)

(72) Inventor: Tso Jen Wang, Irvine, CA (US)

(21) Appl. No.: 15/001,262

(22) Filed: Jan. 20, 2016

(51) Int. Cl. G06Q 10/10; G06F 3/0482; H04L 29/06

(52) U.S. Cl. CPC G06Q 10/103; H04L 63/08; G06Q 10/107; G06F 3/0482

(57) ABSTRACT

The present invention is a system that enable individuals, whether working pro se or part of organizations, to collaborate on work items across electronic networks. The major innovations are specific to the domain of work collaboration: 1) Organization of work topics in a hierarchical and tabular fashion with user interface tailored to traversing any hierarchy with ease; 2) Automatic adjustment of user interface based on the display size of user devices; 3) Use of templates to automate work item creations; 4) Roles that enable collaboration by active participants and viewing by passive stakeholders ; 5) Sharing of digital media within the context of applicable work hierarchies; 6) Notifications, typically sent to smart phones, to alert users regarding work topics that need attention; 7) Exchanges of text messages within the context of applicable work hierarchies.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO A “SEQUENCE LISTING”

Not Applicable

### STATEMENT REGARDING PRIOR DISCLOSURES BY THE INVENTOR

Not Applicable

### BACKGROUND OF THE INVENTION

The present invention pertains to the field of work collaboration using computer technologies. While there are existing systems that facilitate project collaboration, many of the existing systems are often too complex and difficult to use, while others are too simplistic and insufficient for business purposes. Furthermore, existing systems typically lack the necessary mechanism to protect data or enable stakeholders, such as home buyers in real estate transactions, to access needed information. Additionally, the majority of existing systems do not have the ability to present a consistent user interface across user devices with different form factors. Lastly, existing systems do not take full advantage of the advent of smart phones in terms of the sharing of digital media, the use of notifications, and the exchange of instant messages.

### BRIEF SUMMARY OF THE INVENTION

The present invention introduces a combination of several innovations that not only enable active participants to collaborate effectively, but also provide stakeholders the ability to be kept abreast of work status. Specifically, the present invention is a system that displays work data in a hierarchical, tabular views with user interface tailored to traversing any hierarchy with ease. One of the key innovations is the paring of work data in such a way that makes it easy to view and update essential data using devices ranging from those with small form factor such as tablets or smart phones to those with larger form factor such as desktop computers or laptops. The separation of user roles into Administrator, Owner, Doer, and Viewer enables the system to display features and data based on the privileges afforded to the respective roles. Another key innovation is the capability that enables users to share digital media by viewing or downloading media files on a variety of user devices, including, but not limited to, desktop computers, laptops, tablets, and smart phones. Furthermore, activity assignments, retractions, and status changes can he sent via smart phone notifications to provide real time updates. Active participants and passive stakeholders can communicate using instant messages within the context of work hierarchies. In contrast to generic messaging systems where messages are unorganized and therefore arduous to locate or sort through, messages in the present invention are organized by work topics which not only provides the context regarding individual messages but enables easy retrieval regardless of the time lapses from when any given message was created.

### BRIEF DESCRIPTION OF THE DRAWINGS

FIG. 1-A A view of all projects belonging to an organization on a desktop computer.

FIG. 1-B A view of all projects belonging to an organization on a smart phone.

FIG. 2-A A view of open projects belonging to an organization on a desktop computer.

FIG. 2-B A view of open projects belonging to an organization on a smart phone.

FIG. 3-A A view of all tasks within a project on a desktop computer.

FIG. 3-B A view of all tasks within a project on a smart phone (partial view).

FIG. 4-A A view of all activities within a task on a desktop computer.

FIG. 4-B A view of all activities within a task on a smart phone.

FIG. 4-C A view of all activities within a task on a desktop computer with the mouse hovering over a link in the ‘Assigned’ column.

FIG. 4-D A view of all activities in a task, where the activities are sorted by the activity names in descending order, on a desktop computer.

FIG. 5 A view of an open and assigned activity on a desktop computer.

FIG. 6 A view of a completed activity on a desktop computer.

FIG. 7-A A view of the assignment of an activity on a desktop computer.

FIG. 7-B A view of the assignment of an activity on a desktop computer where available Doers are shown.

FIG. 8-A A view of the retraction of an activity on a desktop computer.

FIG. 8-B A view of a retracted activity shown to the Owner on a desktop computer.

FIG. 9 A view of the notification of a retracted assignment on a smart phone.

FIG. 10 A view of a retracted (a.k.a. reassigned) activity shown to the prior assignee on a smart phone.

FIG. 11 A view of the notification of a new assignment on a smart phone.

FIG. 12 A view of an assigned activity on a smart phone.

FIG. 13-A A view of all comments regarding an activity on a desktop computer.

FIG. 13-B A view of all comments regarding an activity on a smart phone (partial view).

FIG. 14 A view of the notification of a new comment on a smart phone.

FIG. 15-A A view of all attachments regarding an activity on a desktop computer.

FIG. 15-B A view of all attachments regarding an activity on a desktop computer, with a file selected from local hard drive.

FIG. 15-C A view of all attachments regarding an activity on a smart phone (partial view).

FIG. 16 A view of all attachments regarding an activity on a desktop computer, where a download link is shown.

FIG. 17-A A view of a PDF file on a desktop computer.

FIG. 17-B A view (listening to) of an MP3 file on a smart phone.

FIG. 18-A A view of the parameters regarding project search on a desktop computer.

FIG. 18-B A view of the result of searching projects on a desktop computer.

FIG. 19-A A view of the parameters regarding task search on a desktop computer.

FIG. 19-B A view of the result of searching tasks on a desktop computer.

FIG. 20-A A view of the result regarding activity search on a desktop computer.

FIG. 20-B A view of the result of searching activities on a desktop computer.

FIG. 21-A A view of the result of regarding attachment search on a desktop computer.

FIG. 21-B A view of the result of searching attachments on a desktop computer.

FIG. 21-C A view of the attachment view, as a result of clicking on an ‘Open’ button in a search result, on a desktop computer.

FIG. 22 A view of the menu items and open projects on a desktop computer.

FIG. 23 A view of all assigned activities to an individual on a smart phone.

FIG. 24-A A view of all open activities belonging to an organization on a desktop computer (partial view).

FIG. 24-B A view of all open & unassigned activities belonging to an organization on a desktop computer (partial view).

FIG. 25 A view of a newly created project, with no task, on a desktop computer.

FIG. 26 A view of the popup regarding the parameters of the real estate sale project template on a desktop computer.

FIG. 27 A view of a project, with tasks automatically created via the real estate sale project template, on a desktop computer.

FIG. 28 A view of all activities in a task, where the name of an activity is being edited, on a desktop computer.

FIG. 29 A view of all activities in a task, where the name of an activity had been edited, on a desktop computer.

FIG. 30 A view of all activities in a task, where the due date of an activity is being edited, on a desktop computer.

FIG. 31 A flow chart depicting the process flow when a user logs in.

FIG. 32 A flow chart depicting the process flow when a user navigates up or down a work hierarchy.

FIG. 33 A flow chart depicting the process flow when a user creates a new project, task, or activity.

FIG. 34 A flow chart depicting the process flow when a user assigns an activity.

FIG. 35 A flow chart depicting the process flow when a user retracts an assignment.

FIG. 36 A flow chart depicting the process flow when a user adds a comment.

FIG. 37-A A flow chart depicting the process flow when a notification needs to be sent.

FIG. 37-B A flow chart depicting the process flow when a user clicks on a notification.

FIG. 38 A flow chart depicting the process flow when a user attaches a digital media file to an activity.

FIG. 39 A flow chart depicting the process flow when a user chooses to download a digital media file attached to an activity.

FIG. 40 A flow chart depicting the process flow when a user chooses to view or listen to a digital media file attached to an activity.

FIG. 41 A flow chart depicting the process flow when a pre-defined template is used to create tasks and activities in a project.

FIG. 42 A flow chart depicting the process flow when a user chooses to sort work data displayed on a user device.

FIG. 43 A flow chart depicting the process flow when a user chooses to undo the edits on the user device.

FIG. 44 A flow chart depicting the process flow when a user chooses a pre-defined view in the Menu.

FIG. 45 A flow chart depicting the process flow when a user chooses to search the data stored in the Serving System.

FIG. 46 A flow chart depicting the process flow regarding the font coloring of due dates.

### DETAILED DESCRIPTION OF THE INVENTION

The present invention will be described fully hereinafter with reference to the accompanying drawings, which are intended to be read in conjunction with the summary, the detailed description, and any embodiments specifically discussed or otherwise disclosed. The invention may, however, be embodied in many different forms and should not be construed as limited to the embodiments set forth herein. Instead, these embodiments are provided by way of illustration such that this disclosure will be thorough, complete, and will convey the full scope of the invention to those skilled in the art. The user interfaces shown in the accompanying drawings, which are screen captures of the reference implementation of the present invention, are in color when captured. The color in the actual screen captures had been changed to gray scale to be in compliance with the pertinent patent application guidelines. As such, the color references in the textual description may not be obvious when viewing the accompanying figures.

The present invention pertains to a system and a method to he used in work collaboration. Specifically, the system and method according to the present invention is a computerized process that enables active participants to collaborate on work projects and passive stakeholders to he kept abreast of progress.

In the present invention, work items are to be organized in a hierarchical fashion such that a project may consist of one or more tasks whereas a task may consist of one or more activities. Work Data' organized in this fashion are to be stored in database tables in the Serving System, which comprises one or more computers, containing the program capable of delivering hierarchical work related data to user devices and receiving data from user devices, as illustrated in the process flow drawings, in conjunction with pertinent storage devices, necessary support peripherals, networking devices, and networking infrastructure.

Project, Task, and Activity tables are three of the Work Data tables. The data fields pertaining to these tables, respectively, are as follows:

Project

| | |
|---|---|
| ID | Unique identifier of a project. |
| Organization ID | Unique identifier of an organization to which the project belongs. The values in |
| | this field are to be sourced from the ID field in the Organization table. |
| Name | Unique name of the project within the organization to which the project |
| | belongs. |
| Status | The completion status of the project. The possible values are ‘Open’ or |
| | ‘Completed’. |
| Due Date | The due date of the project. |
| Duration | The duration of the project. |
| Last Updated By | The ID of the individual who updated the project data most recently. The |
| | values in this field are to be sourced from the ID field in the Person table. |
| Last Updated Timestamp | The timestamp when the project data was last updated. |

Task

| | |
|---|---|
| ID | Unique identifier of a task. |
| Project ID | The ID of the project to which the task belongs. The values in this field are to be |
| | sourced from the ID field in the Project table. |
| Name | Unique name of the task within the project to which to task belongs. |
| Status | The completion status of the task. The possible values are ‘Open’ or |
| | ‘Completed’. |
| Due Date | The due date of the task. |
| Last Updated By | The ID of the individual who updated the task data most recently. The values |
| | in this field are to be sourced from the ID field in the Person table. |
| Last Updated Timestamp | The timestamp when the task data was last updated. |

Activity

| | |
|---|---|
| ID | Unique identifier of an activity. |
| Task ID | Unique identifier of a task to which the activity belongs. The values in this field |
| | are to be sourced from the ID field in the Task table. |
| Name | Unique name of the activity within the task to which the activity belongs. |
| Status | The completion status of the activity. The possible values are ‘Open’ or |
| | ‘Completed’. |
| Due Date | The due date of the activity. |
| Propagated | A flag to indicate whether or not the activity is a propagation of its parent task. |
| | A propagated activity is an activity that has the same name as its parent task |
| | where no other peer activity exists under its parent task. |
| Last Updated By | The ID of the individual who updated the activity data most recently. The |
| | values in this field are to be sourced from the ID field in the Person table. |
| Last Updated Timestamp | The timestamp when the activity data was last updated. |

The respective ID fields in each database table enable the Serving System to formulate views of the work hierarchy in any organization that makes use of the present invention. For example, a database query with the condition ‘Project ID=ID of the pertinent project’ can be used to fetch all tasks in the ‘Task’ table that belong to a given project. Likewise, a database query with the condition ‘ Task ID=ID of the pertinent task’ can be used to fetch all activities in the ‘Activity’ table that belong to a given task. To identify the number of tasks in a given project or the number of activities in a given task that are still ‘Open’, an additional condition ‘Status=Open’ can be added to the aforementioned database queries, respectively.

In addition to ‘Work Data’, the Serving System database contains ‘Control Data’ used in the various process flows to manage data intake and view rendering on user devices. Person, Organization, Role, and Authorization are four of the Control Data tables. The data fields pertaining to these tables, respectively, are as follows:

Person

| | |
|---|---|
| ID | Unique identifier of a person. |
| Login ID | Unique log in identifier of the person. |
| Login Password | Person specific password to be used during identity authentication. |
| Organization ID | Unique identifier of an organization to which the person belongs. The values in |
| | this field are to be sourced from the ID field in the Organization table. A person |
| | needs not belong to an organization. As such, an individual could make use of |
| | the present invention without having to declare any organization affiliation. On |
| | the other hand, a person can belong to more than one organizations. When a |
| | person belongs to more than one organizations, each organization affiliation of |
| | the person is to be stored as a distinct row in the Person table with a unique ID, |
| | a unique Login ID, and an Organization ID pertinent to the respective |
| | organizations. |
| Name | Full name of the person. |
| First Last Initial | The First Name and Last Initial of the person. |
| Email | The primary email address of the person. |
| Phone | The primary mobile phone number of the person. |

Organization

| | |
|---|---|
| ID | Unique identifier of an organization. |
| Type | The type the organization should be classified as. The possible values of this |
| | data field can vary depending on how the present invention is used. For |
| | example, if this field is used to control billings regarding the usage of the |
| | present invention, the possible values could be ‘Corporation’, ‘Education |
| | Institution’, or ‘Charitable Organization’. |
| Name | The name of the organization. |
| Email | The primary email address of the organization. |
| Phone | The primary phone number of the organization. |
| Subscribed | A flag to indicate whether or not the organization has subscribed to the use of |
| | the present invention. |
| Bucket Name | The bucket name the organization is assigned in the cloud storage of digital |
| | media files. |
| Disk Quota | The total disk space allocated to the organization in the cloud storage of digital |
| | media files. |
| Disk Usage | The total disk usage the organization has consumed in the cloud storage of |
| | digital media files. |

Role

| | |
|---|---|
| ID | Unique identifier of a role. |
| Name | Unique name of a role. The possible values in this field are |
| | ‘Administrator’, ‘Owner’, ‘Doer’, and ‘Viewer’. The present |
| | invention could be extended in the future with additional roles. |

Authorization

| | |
|---|---|
| Person ID | Unique identifier of a person. The values in this field are to be |
| | sourced from the ID field in the Person table. |
| Role ID | Unique identifier of a role. The values in this field are to be |
| | sourced from the ID field in the Role table. As noted earlier, |
| | a person can belong to more than one organizations. |
| | Furthermore, a person can have more than one roles within |
| | any given organization. When a person belongs to more than |
| | one organizations or has more than one roles in an organiza- |
| | tion, each role the person has in an organization is to be |
| | stored as a as a distinct row in the Authorization table with |
| | a unique combination of Person ID and Role ID. |

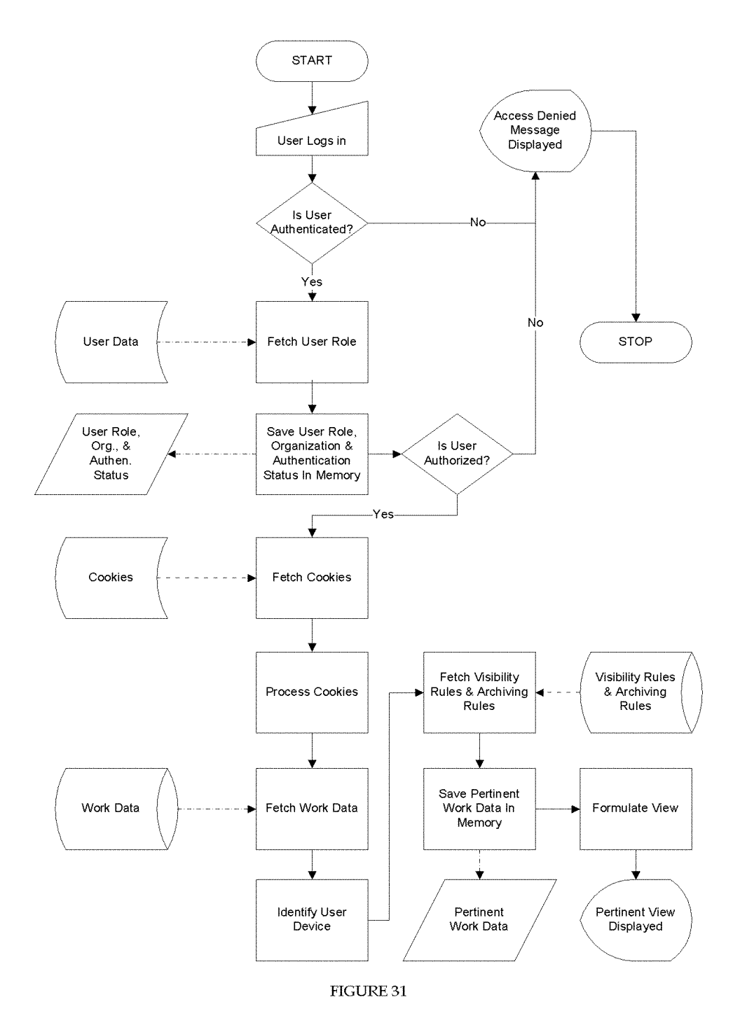

As illustrated in FIG. 31, when a user attempts to log in, the identity authentication is to he processed using the pertinent data from the ‘Login ID’ and ‘Login Password’ fields in the ‘Person’ table. Upon successful log in, the user's role or roles are to be fetched from the ‘Authorization’ table using the ID value from the ‘Person’ table. The logic regarding what data or view a given role is authorized to access could either be programmed into the Serving System or stored in additional tables. Regardless of how authorization logic is to be implemented, the present invention calls for keeping the authentication result, the user organization, and the pertinent user roles in user device memory for instantaneous retrieval during subsequent processing when the user is in session.

To enable user friendly features such as displaying the last view shown to a given user on a user device, cookies are to be used to store pertinent data. Depending on the view to be displayed, pertinent cookies are to he fetched and then processed. As an example, if the last view shown is to search work data, the search term and relevant search parameters are to be stored as cookies such that the same view could be displayed when the user navigates away to another view and then navigates hack to the search view.

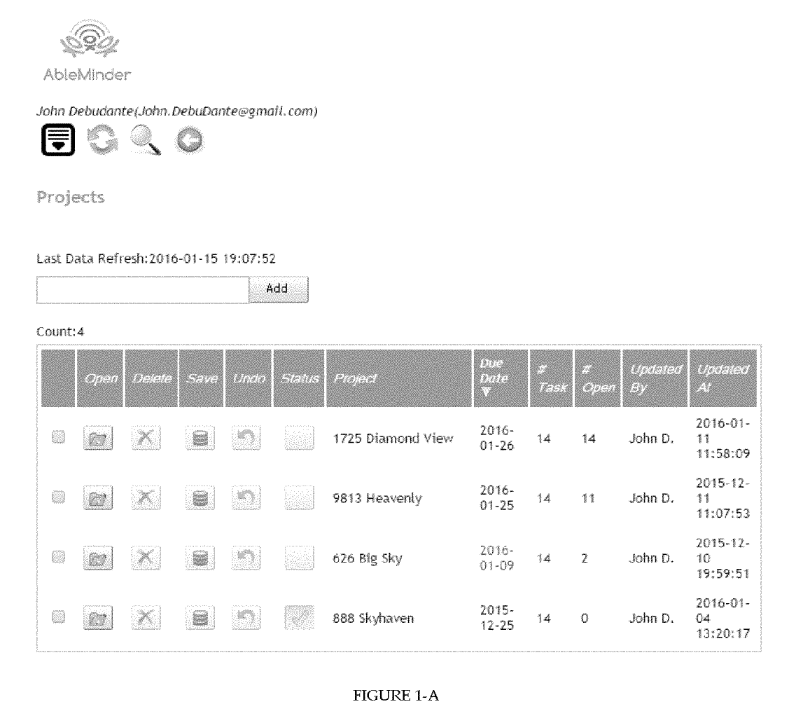

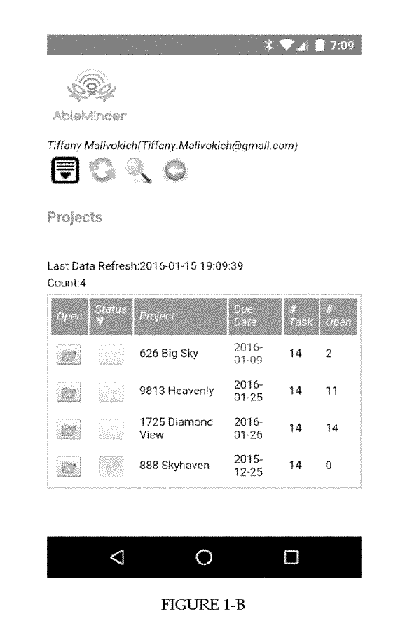

Depending on the view to be displayed, the Serving System is to fetch the pertinent data from one or more of the Work Data tables described above. As shown in FIG. 1-A, the data in the columns ‘Status’, ‘Project’, ‘Due Date’, ‘# Task’, ‘# Open’, ‘Updated By’, and ‘Updated At’ are fetched by using the aforementioned database queries against the Project and Task tables, respectively. The query results are then amalgamated by the Serving System into the view shown in FIG. 1-A.

In order to formulate the requested view properly, the Serving System is to identify the user device being used and then tailor the view based on the display size of the user device. As an example, FIG. 1-B shows the view of several projects as seen on a smart phone, with much smaller display size as compared to the view of the same projects on a desktop computer as shown in FIG. 1-A.

During the view formulation, the Serving System is to fetch arid utilize pertinent Visibility Rules as well as Archiving Rules to filter the Work Data to be displayed to the user. An example of Archiving Rules is displaying only projects that are created within the preceding six months. Exceptions can be included in Archiving Rules whereby individual projects on the exception list could be displayed even though the projects would be filtered out given a pertinent Archiving Rule. Archiving Rules can be added, updated, or deleted by Owners of individual projects or Administrators of the Serving System.

An example of Visibility Rules is limiting visibility of a given activity to the Owner of the project and the Doer of the activity. The user roles retained in user device memory during an earlier step of this process flow are to be utilized to apply pertinent Visibility Rules. Visibility Rules can be added, updated, or deleted by Owners of individual projects or Administrators of the Serving System.

Prior to displaying the requested view to the user, the Serving System is to store pertinent Work Data in user device memory for instantaneous retrieval during subsequent processing when the user is in session.

FIG. 1-A shows an example where a top tier view of a project hierarchy is displayed on a desktop computer. In this particular example, all non-archived projects that belong to a given organization are displayed on a user device. The name and the Login ID, which is an email address in this example, of the user are shown in the view to affirm the identity of the user.

Directly underneath the user identify information are the Menu button as well as one or more Action buttons. The presence of Menu items and Action buttons is to be determined by a number of factors such as user role, view displayed, and visibility rules.

In the reference implementation of the present invention, which are shown in many of the accompanying drawings, the Menu button and Action buttons are displayed as icons:

Menu button

[symbol]

‘Refresh’ button

[symbol]

‘Search’ button

[symbol]

‘Back’ button

[symbol]

‘Up’ button

[symbol]

‘Up Two’ button

[symbol]

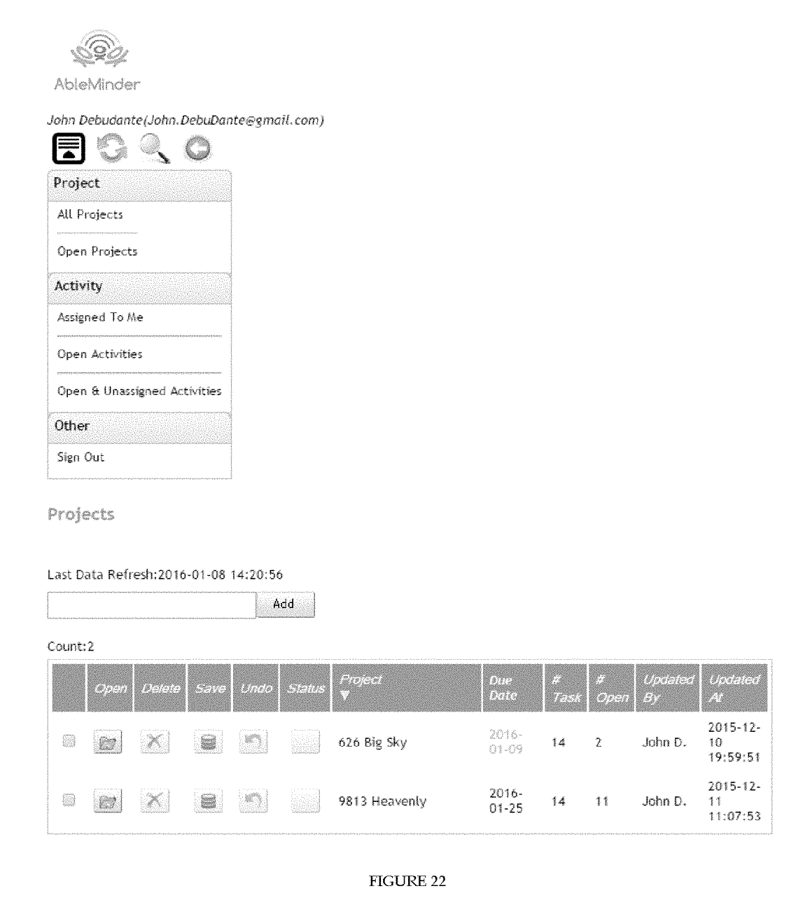

Upon user clicking on the Menu button, a number of Menu items are to he displayed by the Serving System as shown in FIG. 22. The presence of a Menu enables the viewing of data filtered by various predefined criteria. Examples of such criteria include, but are not limited to, ‘All Projects’, ‘Open Projects’, ‘Completed Projects’, ‘Activities Assigned To Me’, ‘Open Activities’, ‘Open and Unassigned Activities’. Other actions such as ‘Sign Out’ of a user session can he included in the Menu.

Clicking on the ‘Refresh’ button by a user is to cause the Serving System to fetch then display pertinent data to the user.

Clicking on the ‘Search’ button by a user is to cause the Serving System to display a view that enables searching of work data stored within Serving System.

Clicking on the ‘Back’ button by a user is to cause the Serving System to display the view that precedes the current view.

Clicking on the ‘Up’ button by a user is to cause the Serving System to display the tier view one level higher than the current view displayed to the user.

Clicking on the ‘Up Two’ button by a user is to cause the Serving System to display the tier view two levels higher than the current view displayed to the user.

Directly underneath the Menu button and Action buttons is the name of the view. In FIG. 1-A, the name of the view is ‘Projects’. Further down in the view is the date and time when the data in the view is last refreshed on the user device. Underneath the timestamp is the field and button to create new projects. Between the field to add a new project and the table containing the project data is the count of the number of projects being displayed.

As shown in FIG. 1-A, one of the key innovations of the present invention is displaying work data in a hierarchical, tabular views with user interface tailored to traversing any hierarchy with ease. The columns in the table fall into two categories: columns containing action buttons and columns containing work data. Columns in these two categories are further described as follows:

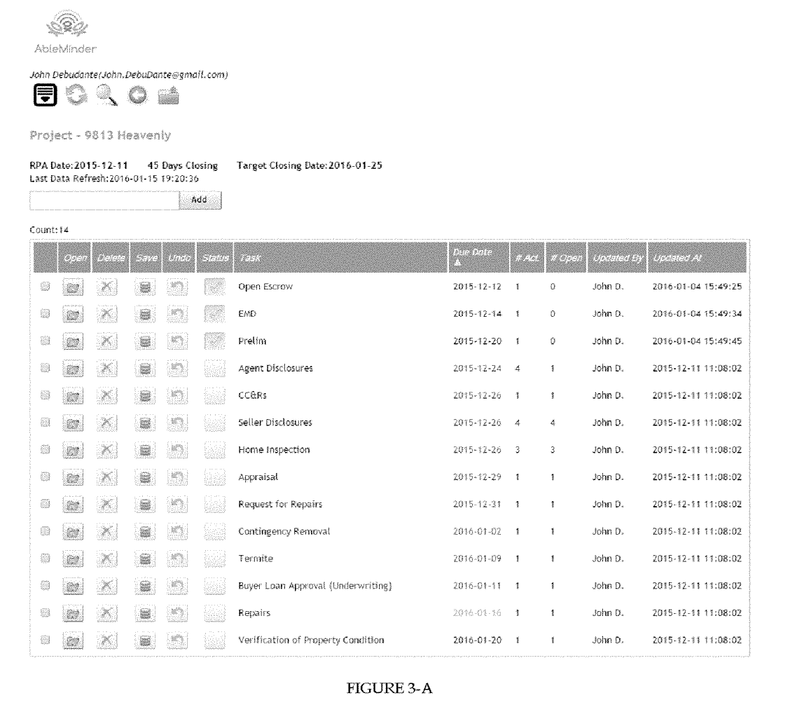

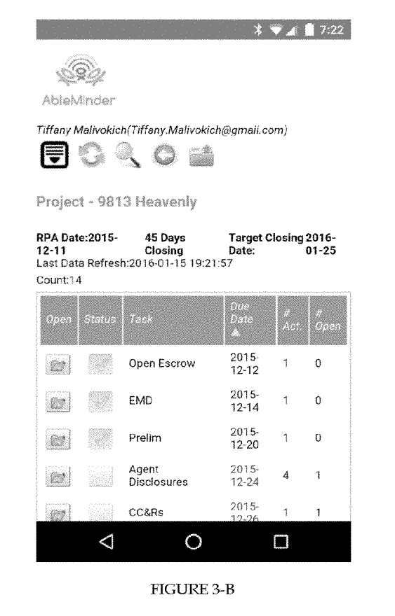

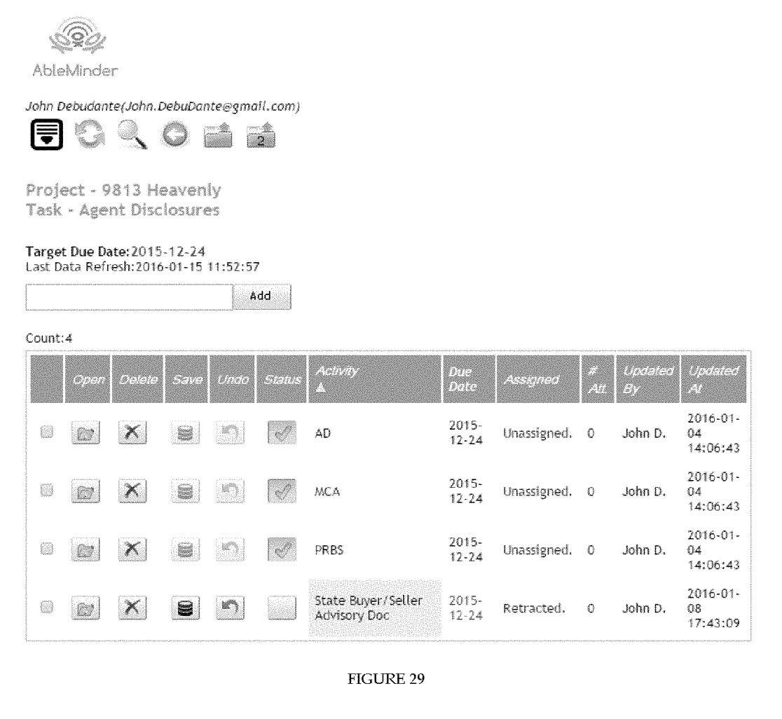

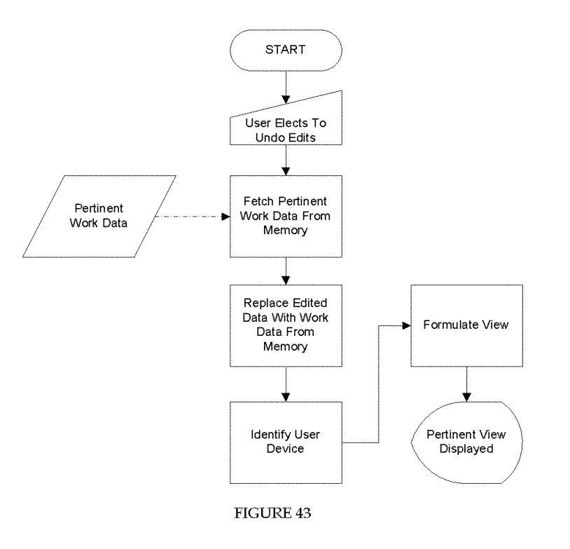

Columns Containing Action Buttons

| | |
|---|---|
| Check Box | Instead of clicking on individual action buttons, a user can click on the heading row in |
| [symbol] unchecked | the ‘Save’ or the ‘Undo’ column to cause the Serving System to take corresponding |
| [symbol] checked | actions on all rows where the check box had been checked. If none of the check box had |
| | been checked prior to a user clicking on the heading row of either the ‘Save’ or the ‘Undo’ |
| | column, then the Serving System is to take no action other than informing the user that |
| | no action will be taken due to the lack of check box selection. |
| Open | Clicking on the ‘Open’ button by a user is to cause the Serving System to show the tier |
| [symbol] | view one level lower than the current view displayed to the user. In the example shown |
| | in FIG. 1-A, clicking on the ‘Open’ button would cause the Serving System to show |
| | all tasks that belong to the project displayed in the same row of the table as the ‘Open’ |
| | button. An example of the result of user clicking on an ‘Open’ button in FIG. 1-A can |
| | be seen in FIG. 3-A. |
| Delete | Clicking on the ‘Delete’ button by a user is to cause the Serving System to delete the |
| [symbol] enabled | pertinent work data stored in the Serving System. The Serving System could restrict the |
| [symbol] disabled | deletion of a project if the project contains one or more tasks. For example, the ‘Delete’ |
| | buttons in FIG. 1-A are shown as disabled because of the existence of tasks belonging |
| | to respective projects. |
| Save | Clicking on the ‘Save’ button by a user is to cause the Serving System to replace the |
| [symbol] enabled | pertinent work data stored in the Serving System with the data edited by the user. The |
| [symbol] disabled | ‘Save’ button in any given row is to be disabled unless work data in the row had been |
| | edited by the user. For example, the ‘Save’ buttons in FIG. 1-A are shown as disabled |
| | because the user had not edited any work data in the view. One of the ‘Save’ buttons in |
| | FIG. 29 is shown as enabled because the used had edited the activity name, and as a |
| | result the edited activity name is highlighted by the Serving System in a distinctive |
| | background color. |
| Undo | Clicking on the ‘Undo’ button by a user is to cause the Serving System to replace edited |
| [symbol] enabled | status, name, or due date with data that are stored in the Serving System (‘Original |
| [symbol] disabled | Data’). As indicated in the text describing FIG. 31, work data pertinent to a given |
| | view are to be stored in user device memory to eliminate the need to fetch the data from |
| | disk storage when needed. As shown in FIG. 43, work data stored in user device |
| | memory are to be retrieved when the ‘Undo’ action is requested. Doing so would provide |
| | a favorable user experience by minimizing the processing time between a user action and |
| | the response from the Serving System as fetching data from disk storage would take |
| | much longer than retrieving data from memory. The ‘Undo’ button in any given row is to |
| | be disabled unless work data in the row had been edited by the user. For example, the |
| | ‘Undo’ buttons in FIG. 1-A are shown as disabled because the user had not edited |
| | any work data in the view. One of the ‘Undo’ buttons in FIG. 29 is shown as enabled |
| | because the used had edited the activity name, and as a result the edited activity name is |
| | highlighted by the Serving System in a distinctive background color. |

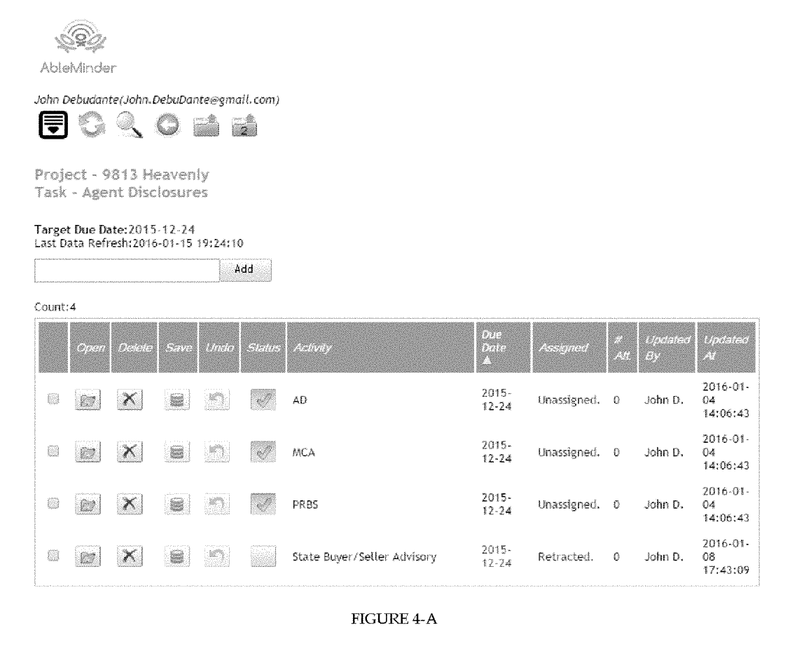

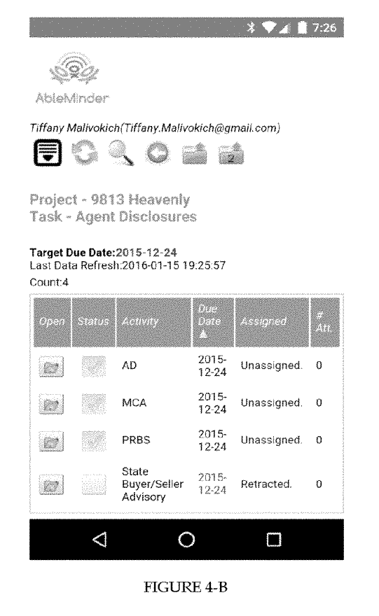

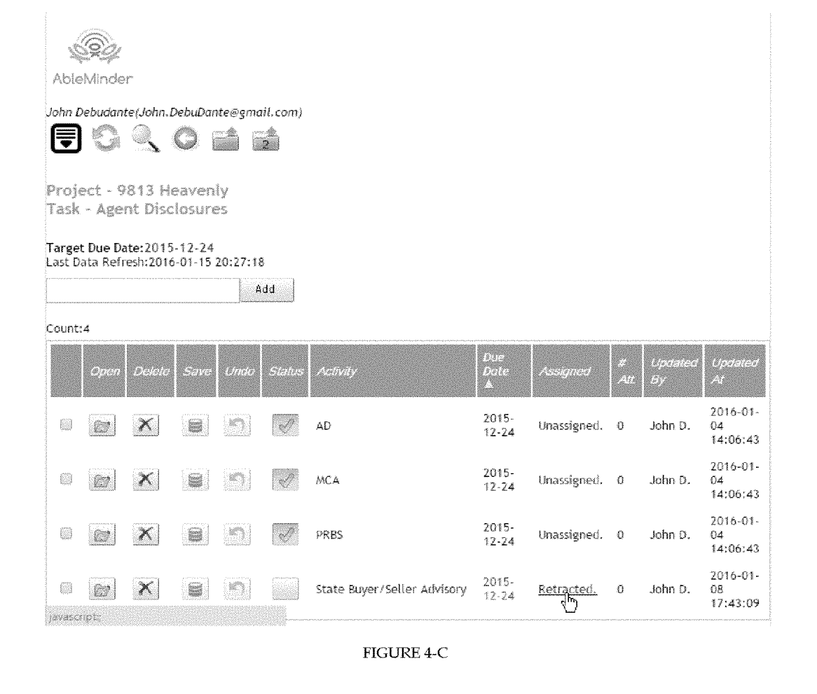

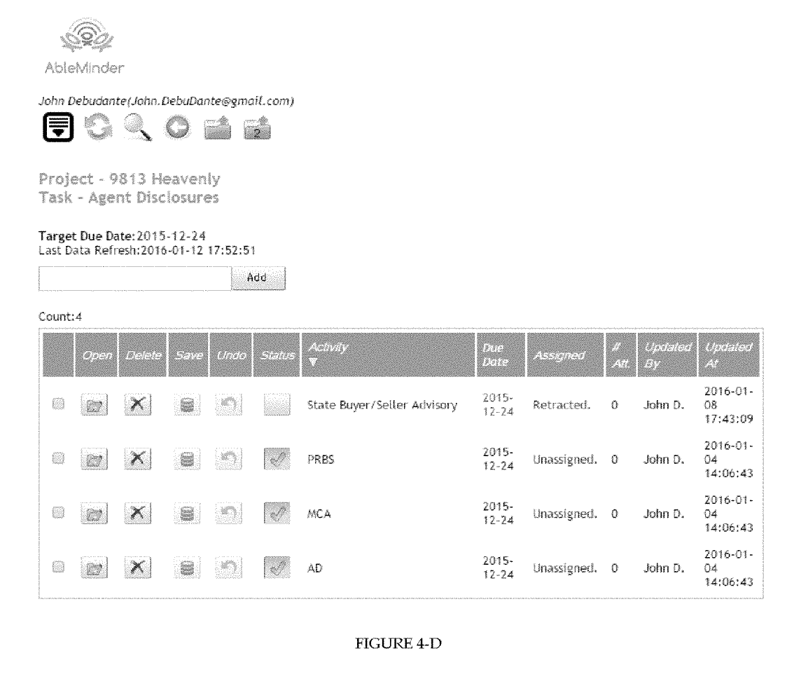

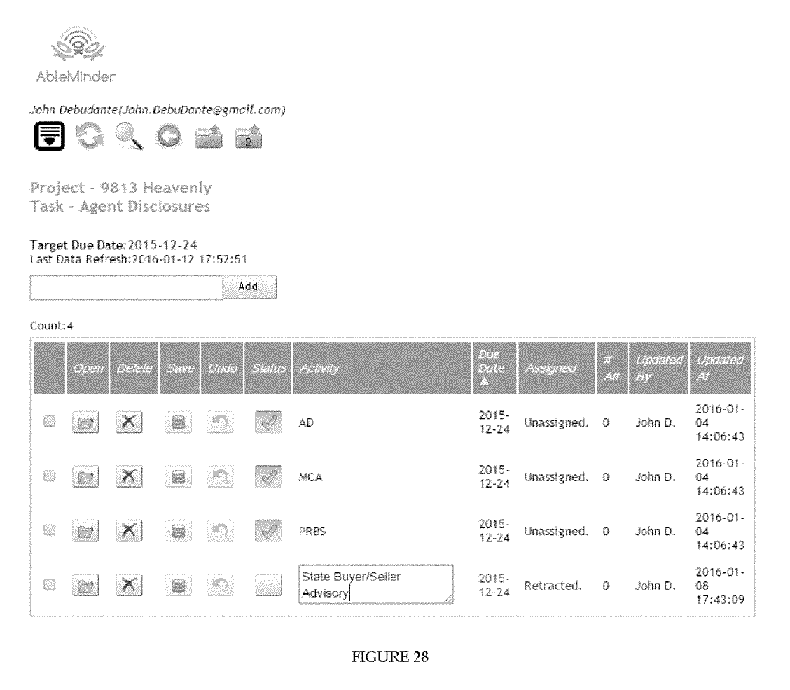

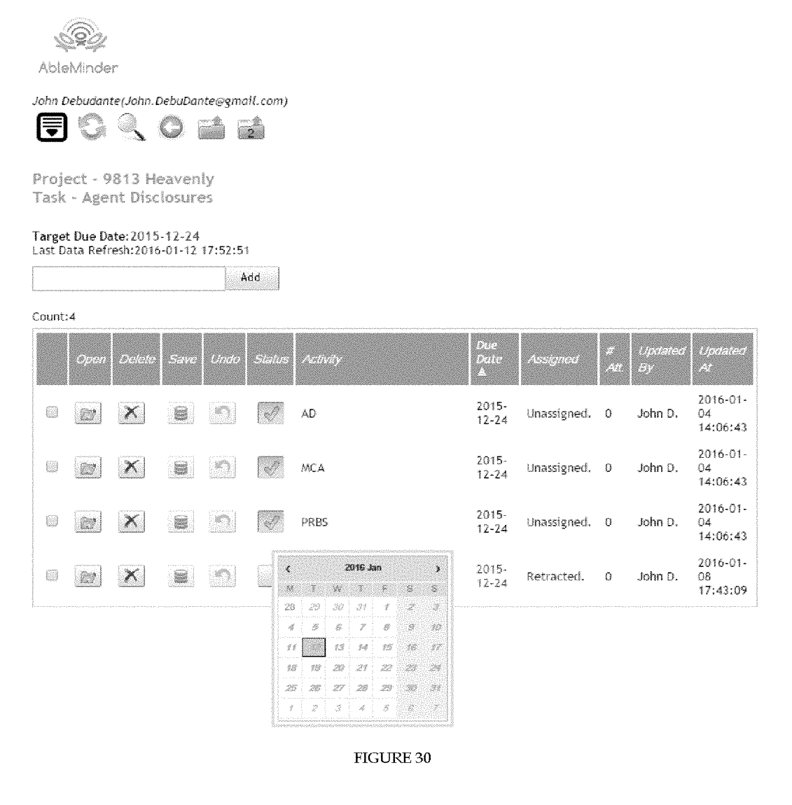

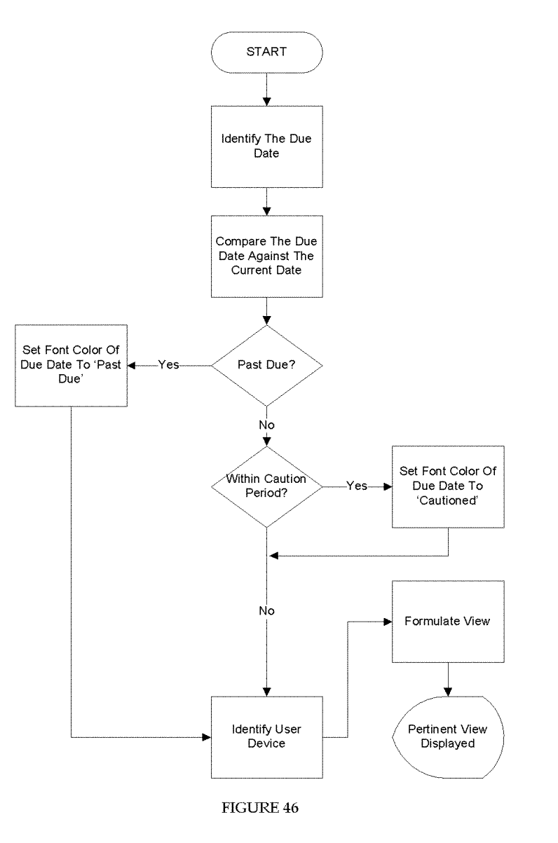

Columns Containing Work Data

| | |
|---|---|
| Status | The status of the work item is to be displayed by the Serving System as a toggle button |
| [symbol] open | depending on the status where the value could be either ‘Open’ or ‘Completed’. When the |
| [symbol] completed | status is ‘Open’, clicking on the Status button is to cause the Serving System to change the |
| | edited status to ‘Completed’. Clicking on the Status button when it is ‘Completed’ is to |
| | cause the Serving System to change the edited status to ‘Open’. The edited status is not to |
| | be saved in the disk storage of the Serving System until after the user clicks on the |
| | pertinent ‘Save’ button. As shown in FIG. 1-A and FIG. 3-A, respectively, the |
| | ‘Status’ button is to be disabled if there are tasks that belong to a project or there are |
| | activities that belong to a task. |
| Project | The name of the work item. The caption of this column is to vary depending on the tier |
| | view. Specifically, the column is to be labeled ‘Project’ in the top tier view whereas the |
| | column is to be labeled ‘Task’ in the second tier view and ‘Activity’ in the third tier view, |
| | respectively. An example of the second tier view is shown in FIG. 3-A. An example |
| | of the third tier view is shown in FIG. 4-A. As shown in FIG. 28, an inline editor |
| | is displayed in the Activity field to enable the user to edit the Activity name. As shown in |
| | FIG. 29, the background color of the Activity field is changed to a color sufficient to |
| | alert users that the value had been edited. |
| Due Date | The due date of the work item. If the status of a work item is ‘Open’, clicking on the date |
| | value in this field is to cause the Serving System to display a ‘Date Picker’ where a |
| | different date could be selected. FIG. 30 is an example showing a Date Picker after |
| | the user clicked on a date value in the Due Date field. As illustrated in FIG. 46, the |
| | font color of the date value in the Due Date field is to be determined depending on the |
| | due date's proximity to the date when the view is displayed. If the due date of a work |
| | item is the same or later than the date of the view presentation, the font color of the date |
| | value is to be set to a color that draws attention that the item is past due. On the other |
| | hand, if the due date of a work item is within the ‘Caution Period’, which is a ‘Time To |
| | Act’ period that precedes the due date, the font color of the date value is to be set to a |
| | color that draws attention that the item will become due after the Caution Period. |
| # Task | The number of tasks that belong to a given project. As indicated in the text describing |
| | FIG. 31, the data in the column are to be produced with the Serving System |
| | amalgamating pertinent data in the ‘Project’ table and the ‘Task’ table. |
| # Open | The number of tasks belonging to a given project with the status being ‘Open’. The data |
| | in this column are to be produced using a process similar to the one used to produce the |
| | data in the “# Task’ column with the difference of adding a condition to fetch tasks that |
| | are ‘Open’. |
| Updated By | The individual who updated the work item most recently. |
| Updated At | The timestamp when the work item was last updated. |

In contrast to displaying a tier view on a desktop computer as shown in FIG. 1-A, an example of the same tier view displayed on a smart phone to a different user is shown in FIG. 1-B. The user shown in FIG. 1-B does not have the Owner role and as a result the view does not include any action button that could alter the work data. Additionally, the ability to add new projects is not available given that the user is not authorized to do so. Furthermore, the ‘Updated By’ and ‘Updated At’ columns are omitted due to the display size of the smart phone.

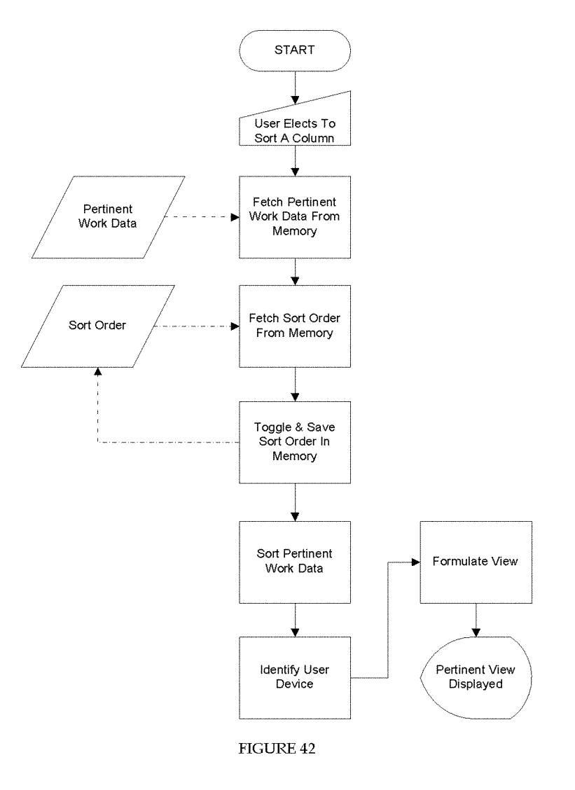

Clicking on the heading of work data columns such as ‘Status’, ‘Project’, Due Date', ‘# Task’, or ‘# Open’ by a user is to cause the Serving System to sort the data displayed in either ascending or descending order of the column where the heading is clicked on. As illustrated in FIG. 42, the pertinent work data as well as the sort order are to he kept in user device memory. Upon detecting that the user elects to sort a column, the Serving System is to toggle the sort order, fetch, and then sort the pertinent work data in memory without reaching into disk storage. If the sort order of a column is kept as ‘ascending’ in memory, toggling the sort order would change the sort order to ‘descending’. Likewise, if the sort order of a column is kept as ‘descending’ in memory, toggling the sort order would change the sort order to ‘ascending’. To indicate which column is being sorted as well as the sort order, the Serving System is to display a triangle representing the sort order in the column heading that is being sorted. For example, FIG. 1-A shows that the work data displayed are sorted in the descending order of the Due Date column. FIG. 1-B shows that the work data displayed are sorted in the descending order of the Status column.

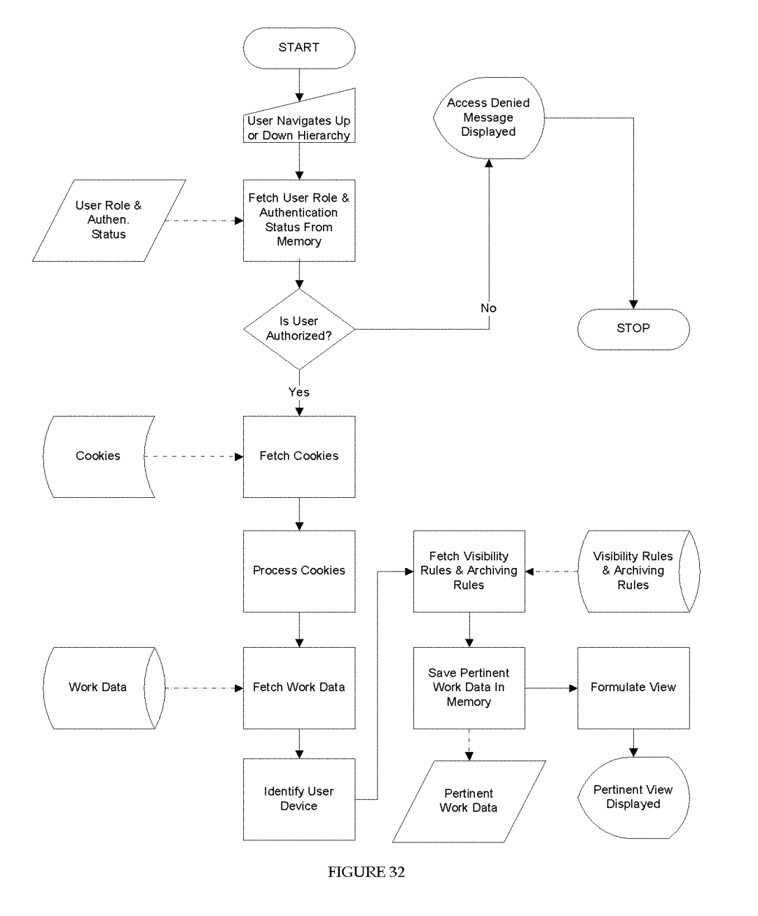

FIG. 32 illustrates the process flow when a user navigates up or down a work hierarchy. To traverse down a hierarchy, the ‘Open’ button in a tabular view of the work data is to be used whereas to navigate up a hierarchy, the ‘Up’ action button or the ‘Up Two’ action button is to be used. Given that the user would have already signed in when the hierarchy traversal takes place, the authentication status and user role are to be fetched from user device memory to minimize the processing time required. Other than the absence of user authentication as well as the retrieval of the authentication status and user role, the process flow illustrated in FIG. 32 is identical to the flow illustrated in FIG. 31, which is described in the preceding section of this document. To ascertain which tier view should be displayed, the Serving System is to base the decision on the tier level of the current view and the action selected by the user. For example, if the current view is at the top tier level, which is a view of all projects, clicking on the ‘Open’ button by the user is to cause the Serving System to display the second tier view, which is a view of all tasks belonging to the chosen project. If the current view is at the third tier level, which is a view of all activities belonging to a given task, clicking on the ‘Up Two’ button by the user is to cause the Serving System to display the top tier view, which is a view of all projects belonging to the organization the user logs in under.

FIG. 3-A is an example of the second tier view that displays all tasks within a project on a desktop computer. The elements of the second tier view are very similar to the elements in the top tier view described in a foregoing section of this document with some exceptions as described below.

Between the name of the view, which is shown as ‘Project—9813 Heavenly’ in FIG. 3-A, and the last data refresh timestamp, the second tier view includes data regarding the start date, the duration, and the due date of the displayed project. The example shown in FIG. 3-A is a real estate purchase transaction. As such, the start date is shown as ‘RPA Date’, which stands for ‘Residential Purchase Agreement Date’. In the reference implementation of the present invention, an RPA date is considered the start date of a real estate purchase transaction. The Target Closing Date in a real estate purchase transaction is the due date of the project. The duration of the project is displayed as the time period that leads to the target closing date, which is displayed as ‘45 Days Closing’ in FIG. 3-A.

Instead of displaying ‘Project’ as the heading label of the work item name column as shown in FIG. 1-A, ‘Task’ is displayed as the heading label of the corresponding column in FIG. 3-A. The number of activities that belong to a given task are shown in the column with heading label as ‘# Act.’ in FIG. 3-A, which is in contrast to the corresponding column heading labeled as ‘# Task’ in FIG. 1-A.

Similar to FIG. 1-B, FIG. 3-B is the same second tier view as FIG. 3-A but displayed on a smart phone to a different user. As in the example shown in FIG. 1-B, the user in FIG. 3-B does not have the authority to add new task or alter existing tasks.

FIG. 4-A is an example of the third tier view that displays all activities within a task on a desktop computer. The elements of the third tier view are very similar to the elements in the top or second tier view described in a foregoing section of this document with some exceptions as described below.

In addition to the selected project name, which is ‘9813 Heavenly’, the name of the view includes the name of the selected task, which is ‘Agent Disclosures’ in FIG. 4-A. Directly underneath the view name is the due date of the selected task. As described in a foregoing section of this document and illustrated in FIG. 46, the Serving System is to display the due date in a color that draws attention to a past due work item. In the example shown in FIG. 4-A, the task is past due so the due date is in red color although the red color had been converted to gray scale, for inclusion of the view as a drawing, so the red color of the due date is not apparent.

Instead of displaying ‘Project’ as the heading label of the work item name column as shown in FIG. 1-A or ‘Task’ as shown in FIG. 3-A, ‘Activity’ is displayed as the heading label of the corresponding column in FIG. 4-A. The number of attachments that belong to a given activity are shown in the column with heading label as ‘# Att.’ in FIG. 4-A, which is in contrast to the corresponding column heading labeled as ‘# Task’ in FIG. 1-A or “# Act.” in FIG. 3-A. A column with heading labeled as ‘Assigned’ is unique to the third level view. The possible values in the ‘Assigned’ column are:

| | |
|---|---|
| Person Name | The individual assigned to the activity. |
| Unassigned | The activity has not been assigned to anyone. |
| Retracted | The activity had been assigned to an individual |
| | at one point but was subsequently retracted. |

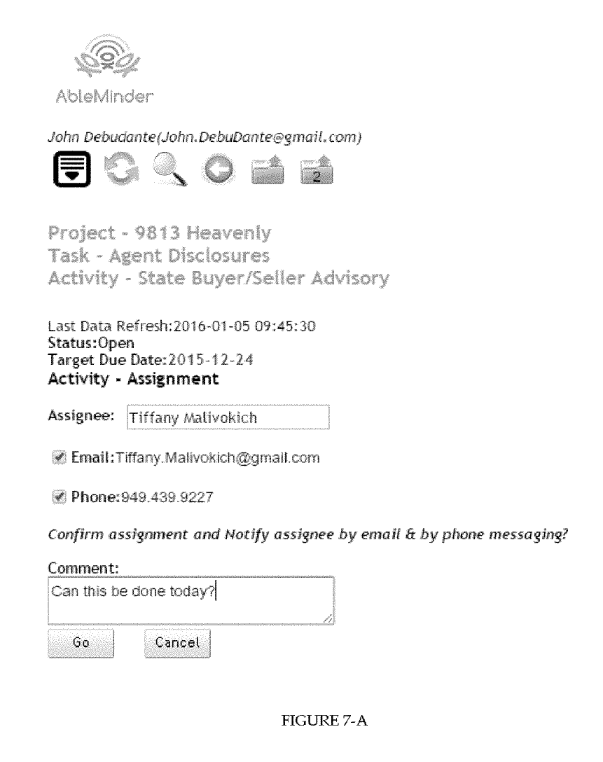

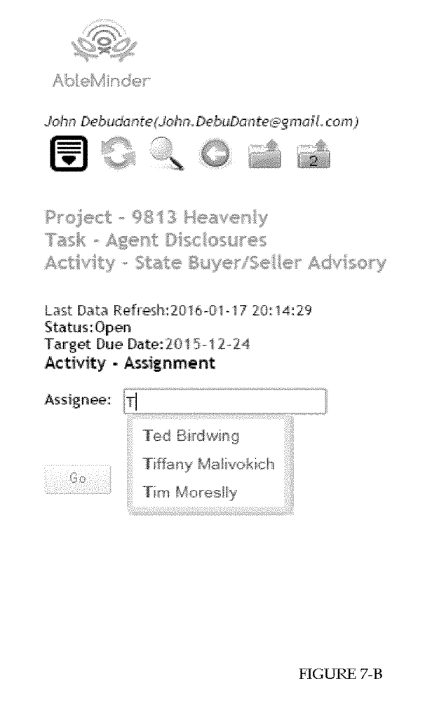

If a user is authorized to assign activities to individuals, known as Doers', the values in the ‘Assigned’ column are to be displayed as hyperlinks. On a desktop computer, the Serving System is to display a hint, such as a ‘Hand’ icon, when the mouse hovers over a hyperlink in the ‘Assigned’ column as shown in FIG. 4-C. Clicking on a hyperlink in the ‘Assigned’ column by a user is to cause the Serving System to display a view that enables the user to assign the activity to a Doer as shown in FIG. 7-A. Assignment is described in details in a following section of this document. As indicated by the direction of the triangle in the Due Date column heading, the activities shown in FIG. 4-A are sorted in the ascending order of Due Date.

Similar to FIG. 1-B or FIG. 3-B, FIG. 4-B is the same third tier view as FIG. 4-A but displayed on a smart phone to a different user. As in the examples shown in FIG. 1-B or FIG. 3-B, the user in FIG. 4-B does not have the authority to add new activity or alter existing activities.

FIG. 4-D shows an example of a third tier view where all activities belonging to a given task are sorted in the descending order of Activity Name.

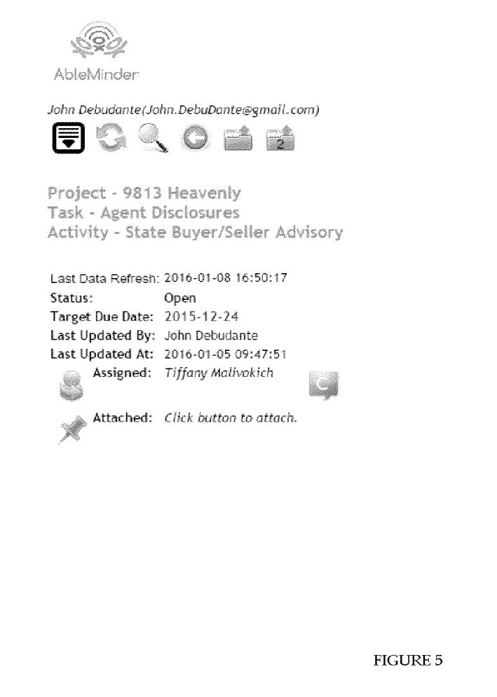

FIG. 5 shows an example of the fourth tier view of a work hierarchy, which is the view of an open activity, on a desktop computer. The Menu button and Action buttons that appear in the other tier views, as described in foregoing sections of this document, also appear in the fourth tier view. In addition to including the selected project name and task name, the view name of the fourth tier view also includes the selected activity name, which is shown as ‘Activity - State Buyer/Seller Advisory’ in FIG. 5. Further down in the view is the date and time when the data in the view is last refreshed on the user device.

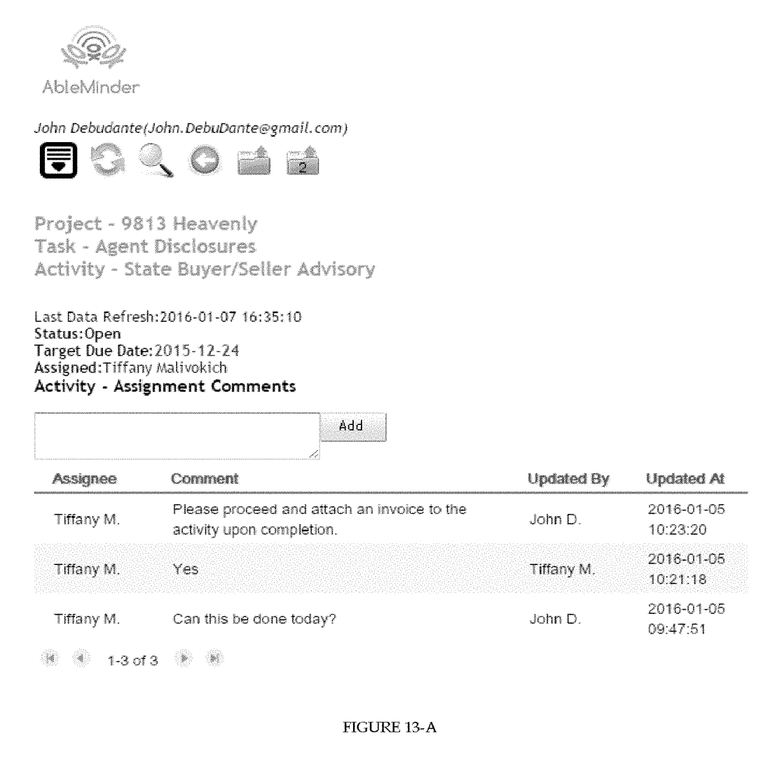

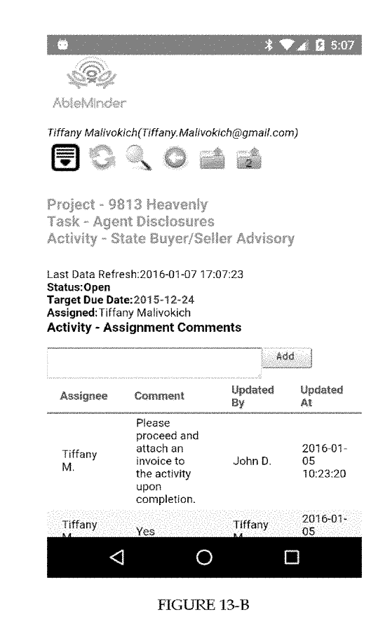

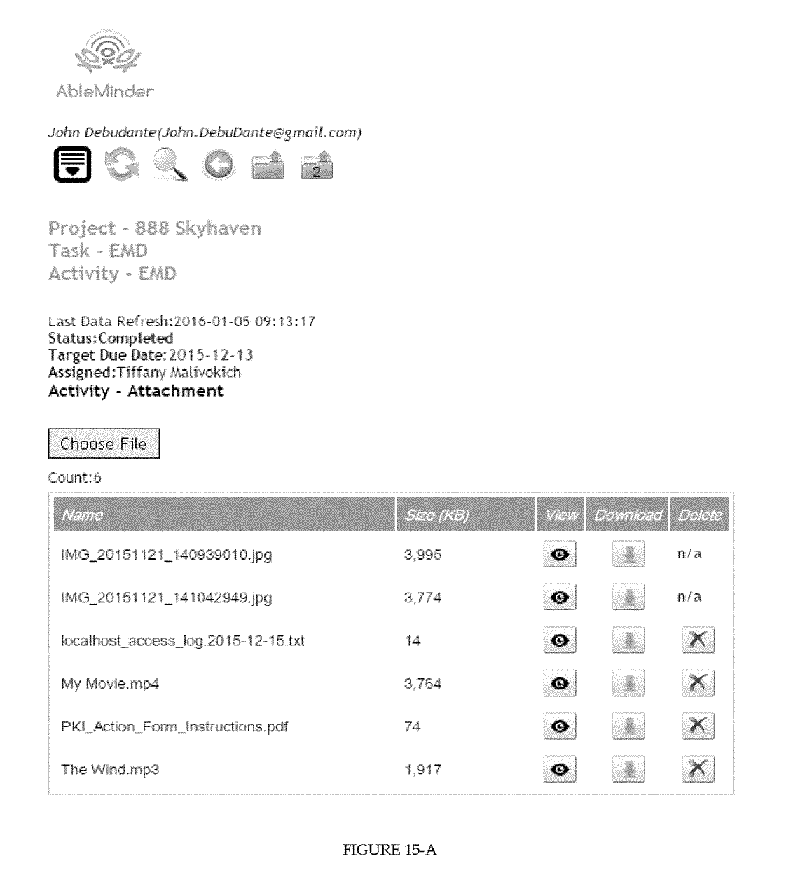

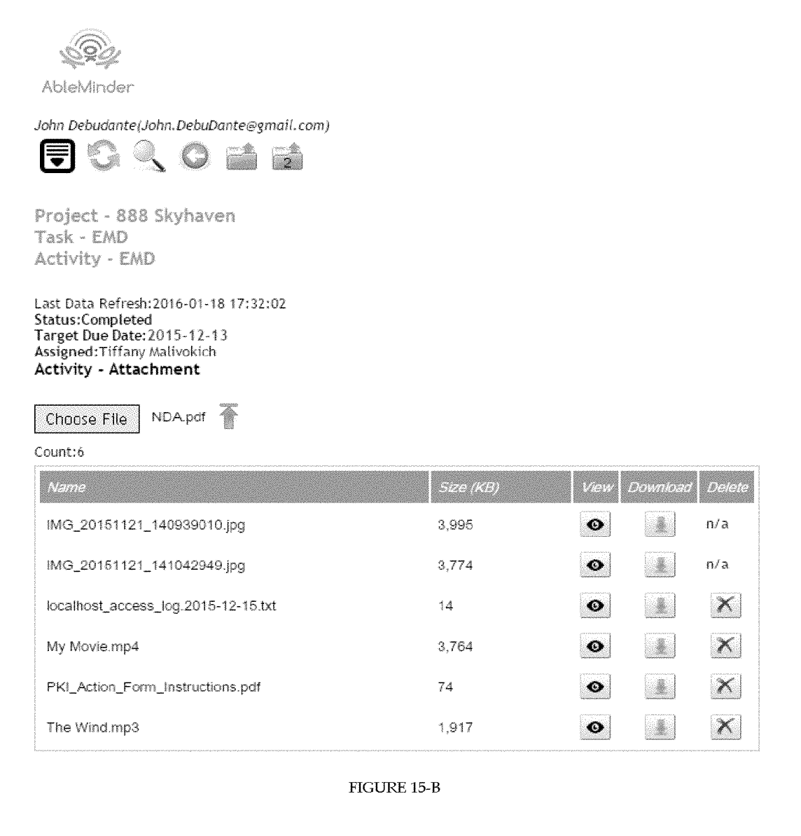

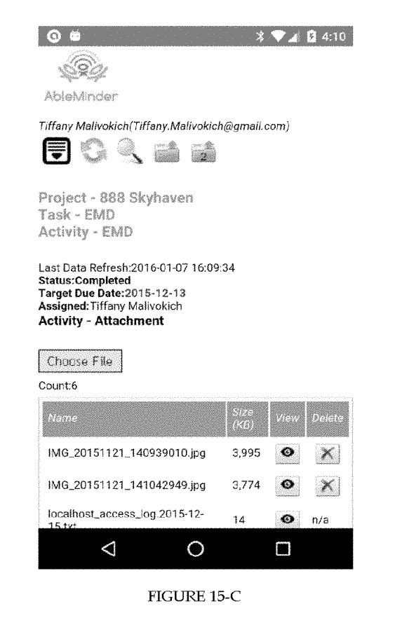

In contrast to displaying multiple work items in a table where the individual data fields are organized horizontally, the data fields pertaining to a single activity are organized vertically. Uniquely present in the fourth tier view are three Activity Action buttons as described below:

| | |
|---|---|
| Assign | Clicking on the ‘Assign’ button by a user is to cause the Serving System to display a view, as |
| [symbol] | shown in FIG. 7-A, that enables the user to assign the selected activity to a Doer. |
| | Assignment is described in details in a following section of this document. |
| Comment | Clicking on the ‘Comment’ button by a user is to cause the Serving System to display a view, |
| [symbol] | as shown in FIG. 13-A, that enables the user to see all existing comments and add |
| | additional comments regarding an activity. The ability to add comments is described in |
| | details in a following section of this document. |
| Attach | Clicking on the ‘Attach’ button by a user is to cause the Serving System to display a view, as |
| [symbol] | shown in FIG. 15-A, that enables the user to see all existing attached digital media files |
| | (‘attachments’) and add additional attachments regarding an activity. The ability to add |
| | attachments is described in details in a following section of this document. |

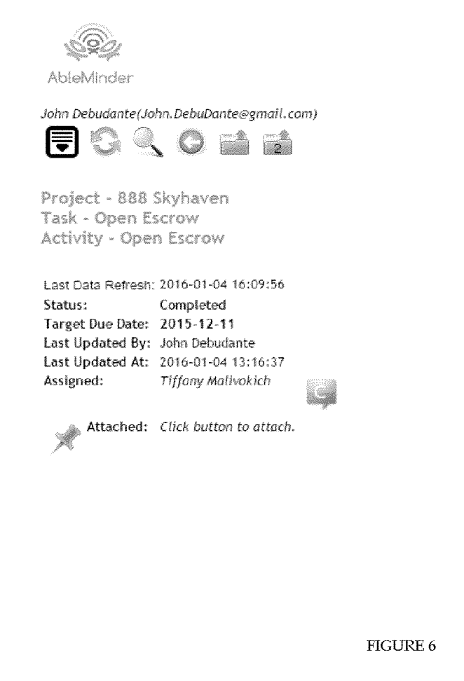

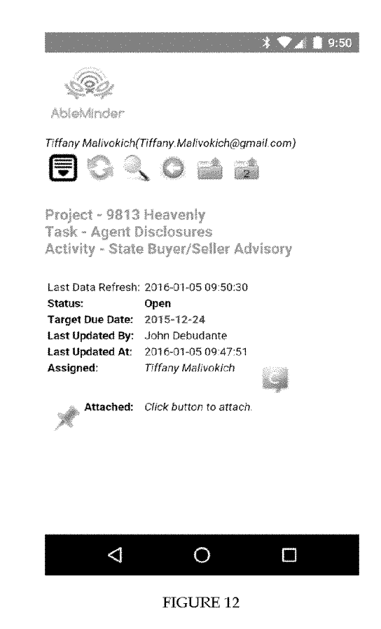

Visibility rules in the Serving System are to determine whether any of the three Activity Action buttons is visible based on user role and activity status. One example of the visibility rules is the Assign button is only to be displayed in open activities. The activity as shown in FIG. 6 is completed and therefore the Assign button is not visible. Another example of the visibility rules is that only the Project Owner of an activity is to have access to the Assign button concerning the activity. The user as shown in FIG. 5 has the Project Owner role so the Assign button is visible given that the activity is open. The user as shown in FIG. 12 has the Doer role, given the user is the assignee of the activity, and therefore does not have access to the Assign button.

The presentation of work data in a hierarchical, tabular views with user interface tailored to traversing any hierarchy with ease is the bedrock that enables the present invention to be innovative and valuable as a tool for work collaboration as well as sharing. The hierarchical, tabular views serve as the framework within which work collaboration can be conducted and shared using computing devices accessible to consumers or business users alike.

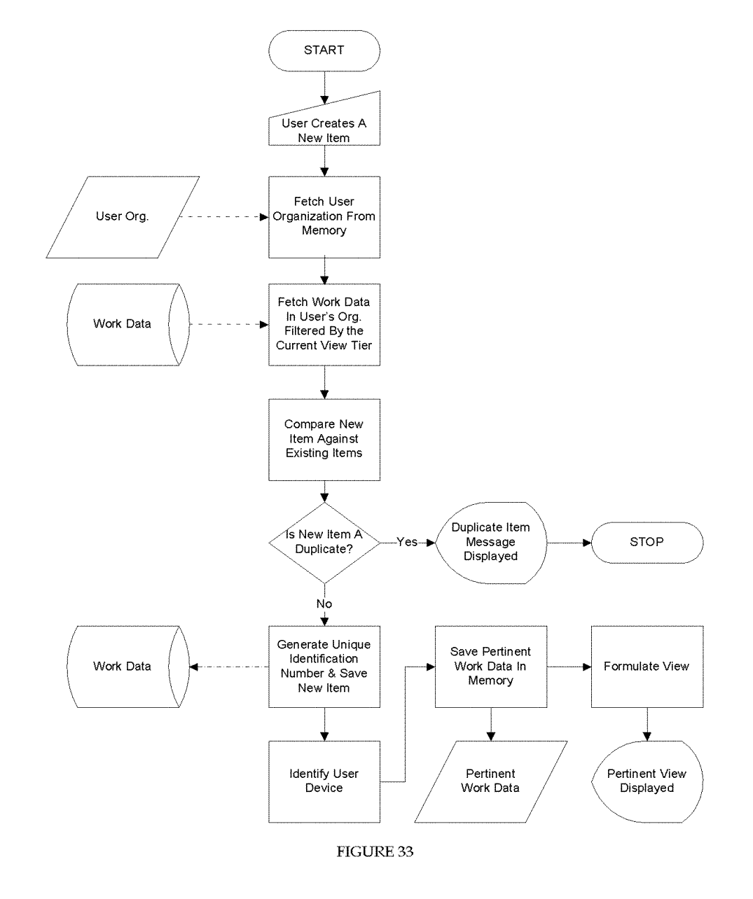

FIG. 33 illustrates the process flow when a user creates a new project, task, or activity. The process of creating a new project, task, or activity starts by a user entering the name of a new work item and clicking on the ‘Add’ button as shown in FIG. 1-A, FIG. 3-A, and FIG. 4-A, respectively. Upon receiving the newly entered work item name, the Serving System is to fetch user organization data from user device memory. The user organization data is then to be used by the Serving System to fetch all pertinent work items from disk storage filtered by the current view level. For example, if the current view level is the top tier, the Serving System is to fetch all projects belonging to the organization associated with the user upon log in. If the current view level is the second tier, the Serving System is to fetch all tasks belonging to the selected project within the organization associated with the user upon log in. Once all pertinent work items are available, the Serving System is to compare the name of the newly entered work item against the names of the fetched work items to determine if the newly entered work item is a duplicate. If the newly entered work item is a duplicate, the Serving System is to inform the user and terminate the creation process. Otherwise, the Serving System is to generate a unique identification number, based on an algorithm that guarantees uniqueness, and save the newly created work item in disk storage. Afterwards, the process steps in FIG. 33 are identical to the corresponding steps shown in FIG. 31 as described in a foregoing section of this document.

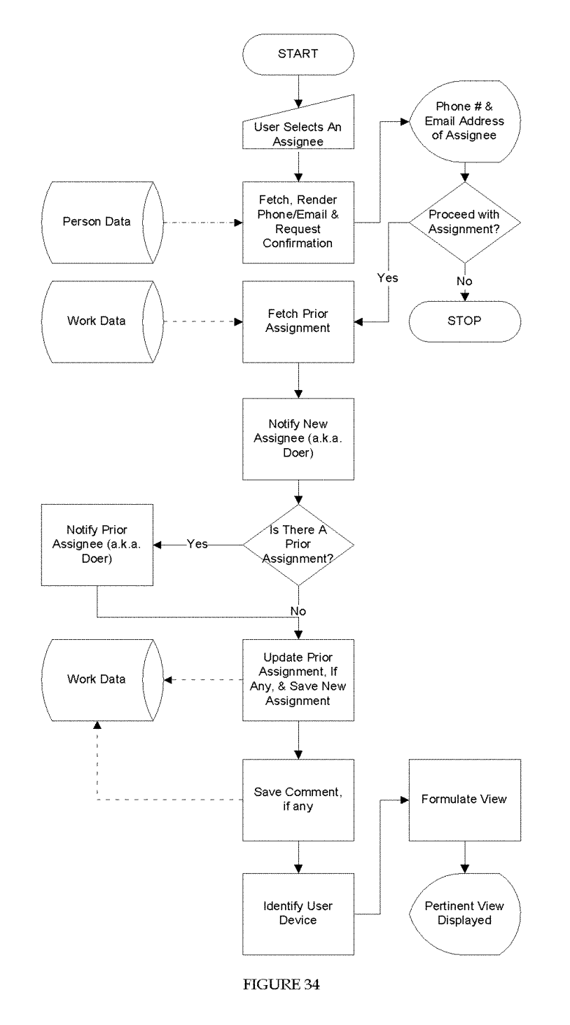

FIG. 34 illustrates the process flow when a user assigns an activity. An example of the view that enables activity assignments is shown in FIG. 7-A. The process of assigning an activity starts by a user selecting the name of an individual from a pool of Doers available to the organization of the user. FIG. 7-B shows an example where there are three available Doers when the user enters the letter ‘T’ in the ‘Assignee’ text field. Upon user selecting an assignee, the Serving System is to fetch the phone number as well as email address, from the ‘Person’ table described in a foregoing section of this document, and display the information in the view to seek user confirmation regarding the assignment.

If the user elects to click on the ‘Cancel’ button shown in FIG. 7-A, the Serving System is to terminate the activity assignment. On the other hand, if the user elects to click on the ‘Go’ button shown in FIG. 7-A, the Serving System is to notify the new Doer and then determine if the activity had been previously assigned by formulating a query against the ‘Assignment’ table, that contains data fields as described below, with the conditions ‘Activity ID=ID of the activity being assigned’ and ‘Action=Assigned’:

Assignment

| | |
|---|---|
| ID | Unique identifier of an assignment. |
| Action | A indicator to record which action had been taken regarding the assignment of |
| | an activity to a Doer. The possible values are ‘Assigned’ or ‘Retracted’. |
| Activity ID | The ID of the activity that is being assigned. The values in this field are to be |
| | sourced from the ID field in the Activity table. |
| Person ID | The ID of the Doer assigned to an activity. The values in this field are to be |
| | sourced from the ID field in the Person table. |
| Last Updated By | The ID of the individual who updated the assignment data most recently. The |
| | values in this field are to be sourced from the ID field in the Person table. |
| Last Updated | The timestamp when the assignment data was last updated. |
| Timestamp | |

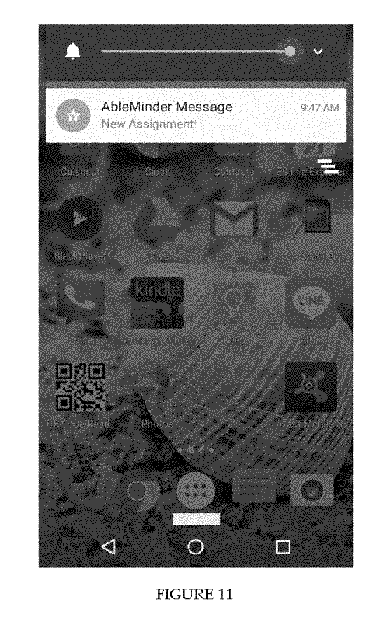

If there is a prior assignment regarding the selected activity, the Serving System is to notify the assignee listed in the prior assignment. In this case the prior assignment is considered to be retracted. Notification is described in details in a following section of this document. After all necessary notifications are completed, the Serving System is to add a record in the ‘Assignment’ table containing the ID of the activity being assigned, the ID of the new assignee, and ‘Assigned’ as the value of the ‘Action’ field. If there is a prior assignment regarding the selected activity, the Serving System is to update the prior assignment record with ‘Retracted’ as the value of the ‘Action’ field. If any comment is added by the user, the Serving System is to save the comment in the ‘Assignment Comment’ table, which is described in a following section of this document. Afterwards, the process steps in FIG. 34 are similar to the corresponding steps shown in FIG. 31 as described in a foregoing section of this document, with the exception that the pertinent work data already exist in user device memory and therefore need not be saved again. FIG. 5 shows the result of an assigned activity on a desktop computer of the project Owner. FIG. 11 shows the notification message that appears on a smart phone of the Doer indicating that there is a new assignment. Clicking on the notification message by the Doer is to cause the Serving System to display the view shown in FIG. 12, which displays the name of the Doer as the assignee as well as the ‘Comment’ and ‘Action’ buttons.

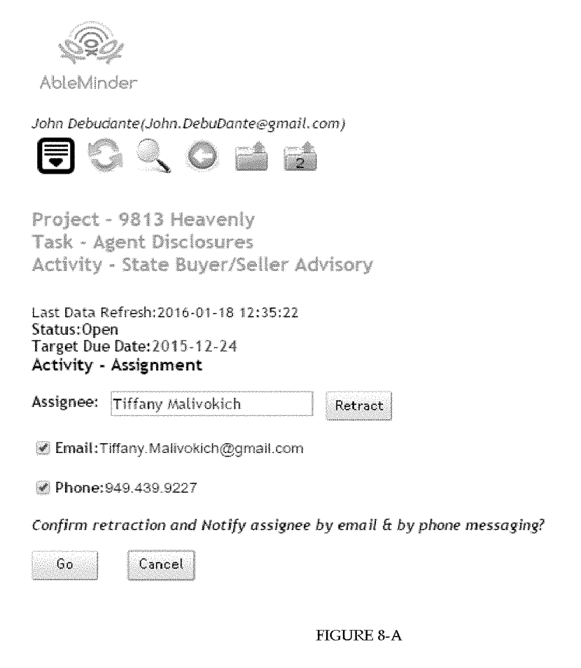

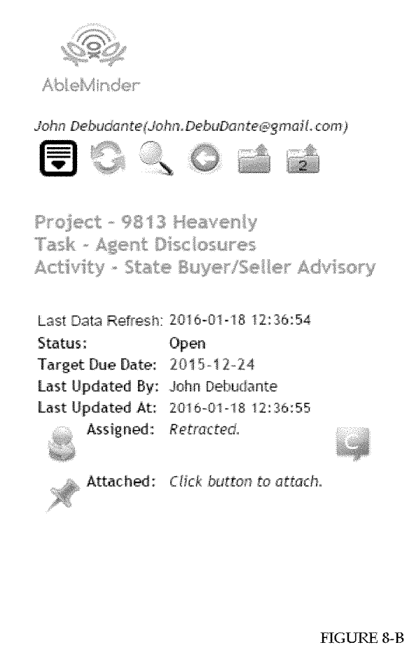

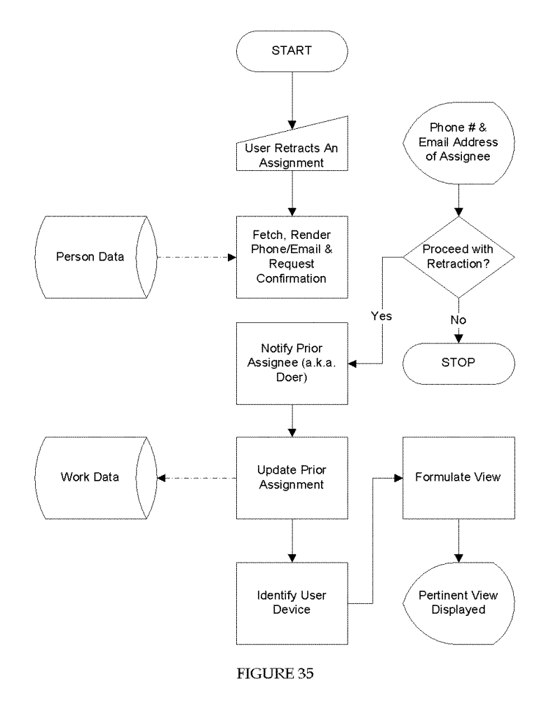

The act of assignment retraction can either be carried out as part of a reassignment as described in the preceding section of this document or as a distinct action by a user as described below. FIG. 35 illustrates the process flow when a user retracts an assignment as a distinct action. An example of the view that enables assignment retractions as distinct actions is shown in FIG. 8-A. The distinct action of assignment retraction starts by a user clicking on the ‘Retract’ button, upon which the Serving System is to fetch the phone number as well as email address, from the ‘Person’ table described in a foregoing section of this document, and display the information in the view to seek user confirmation regarding the retraction.

If the user elects to click on the ‘Cancel’ button shown in FIG. 8-A, the Serving System is to terminate the activity retraction. On the other hand, if the user elects to click on the ‘Go’ button shown in FIG. 8-A, the Serving System is to notify the prior assignee shown in FIG. 8-A that the prior assignment has been retracted. After the notification is completed, the Serving System is to update the prior assignment record with ‘Retracted’ as the value of the ‘Action’ field. Afterwards, the process steps in FIG. 35 are identical to the corresponding steps shown in FIG. 34 as described in a foregoing section of this document.

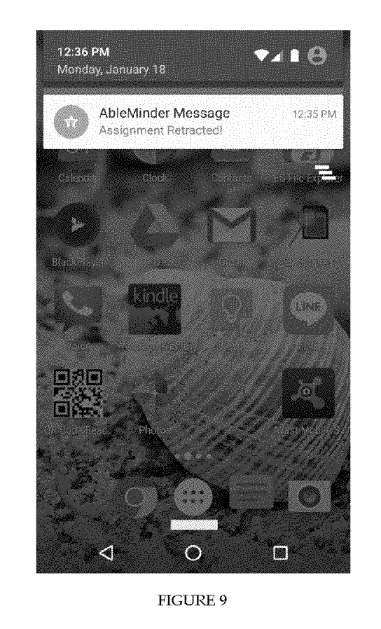

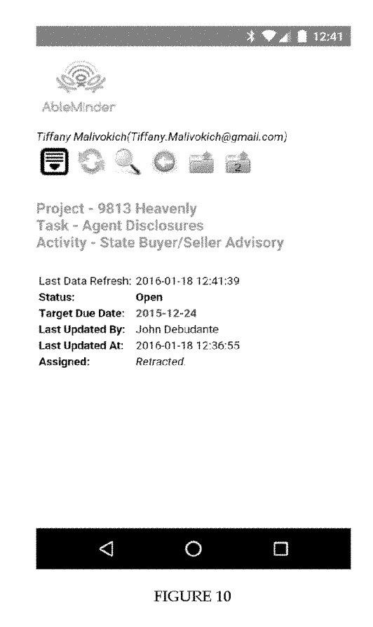

FIG. 8-B shows the result of an activity on a desktop computer of the project Owner where a prior assignment has been retracted. FIG. 9 shows the notification message that appears on a smart phone of the prior assignee indicating that an assignment has been retracted. Clicking on the notification message by the prior assignee is to cause the Serving System to display the view shown in FIG. 10. In contrast to the view shown in FIG. 12, the name of the current assignee appears as ‘Retracted’ to prevent the prior assignee from accessing the information regarding the current assignment, if any. Furthermore, the ‘Comment’ and ‘Attach’ buttons are not visible given that the Doer is no longer assigned to the activity.

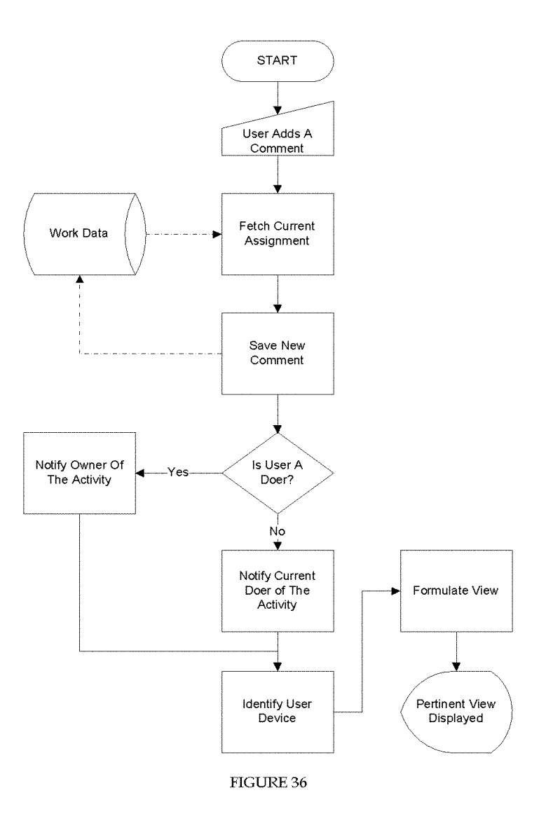

The act of adding a comment to an assignment of an activity can either be carried out as part of the act of assignment as described in a foregoing section of this document or as a distinct action by a user as described below. FIG. 36 illustrates the process flow when a user adds a comment to an assignment of an activity as a distinct act. An example of the view that enables adding comments to an activity assignment is shown in FIG. 13-A, which is the view displayed by the Serving System after a user clicks on the ‘Comment’ button in the fourth tier view. As described in a foregoing section of this document, the ‘Comment’ button is only visible to authorized users in a fourth tier view. Upon user adding a comment and then clicking on the ‘Add’ button, the Serving System is to fetch the current assignment from the ‘Assignment’ table and then save the comment in the ‘Assignment Comment’ table that contains data fields as described below:

Assignment Comment

| | |
|---|---|
| ID | Unique identifier of an assignment. |
| Assignment ID | Unique ID of the assignment to which the comment applies. The values in this |
| | field are to be sourced from the ID field in the Assignment table. |
| Activity ID | The ID of an activity associated with the assignment. The values in this field are |
| | to be sourced from the ID field in the Activity table. |
| Comment | The comment text. |
| Last Updated By | The ID of the individual who added the comment. The values in this field are to |
| | be sourced from the ID field in the Person table. |
| Last Updated | The timestamp when the comment was added. |
| Timestamp | |

If the user who added the comment is a Doer, the Serving System is to notify the Owner of the activity. Otherwise, which means the user who added the comment is the project Owner, the Serving System is to notify the current assignee, i.e., the Doer, of the assignment. Afterwards, the process steps in FIG. 36 are identical to the corresponding steps shown in FIG. 34 as described in a foregoing section of this document

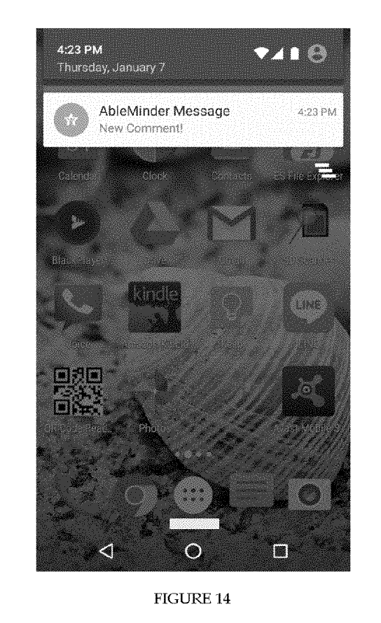

FIG. 14 shows the notification message that appears on a smart phone of the Doer indicating that there is a new comment. Clicking on the notification message by the Doer is to cause the Serving System to display the view shown in FIG. 13-B, which is the smart phone version of the view shown in FIG. 13-A, where the Doer of an assignment can add comments.

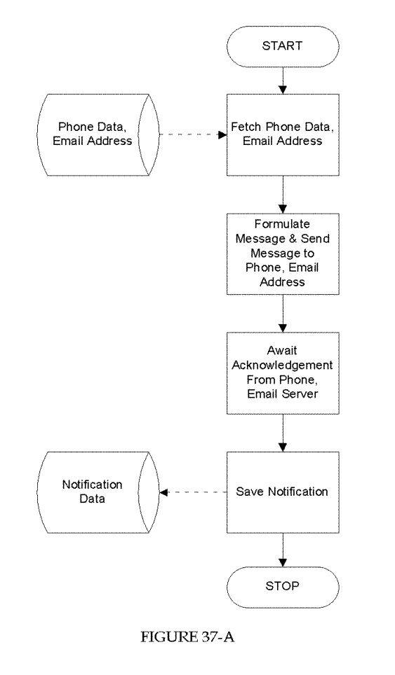

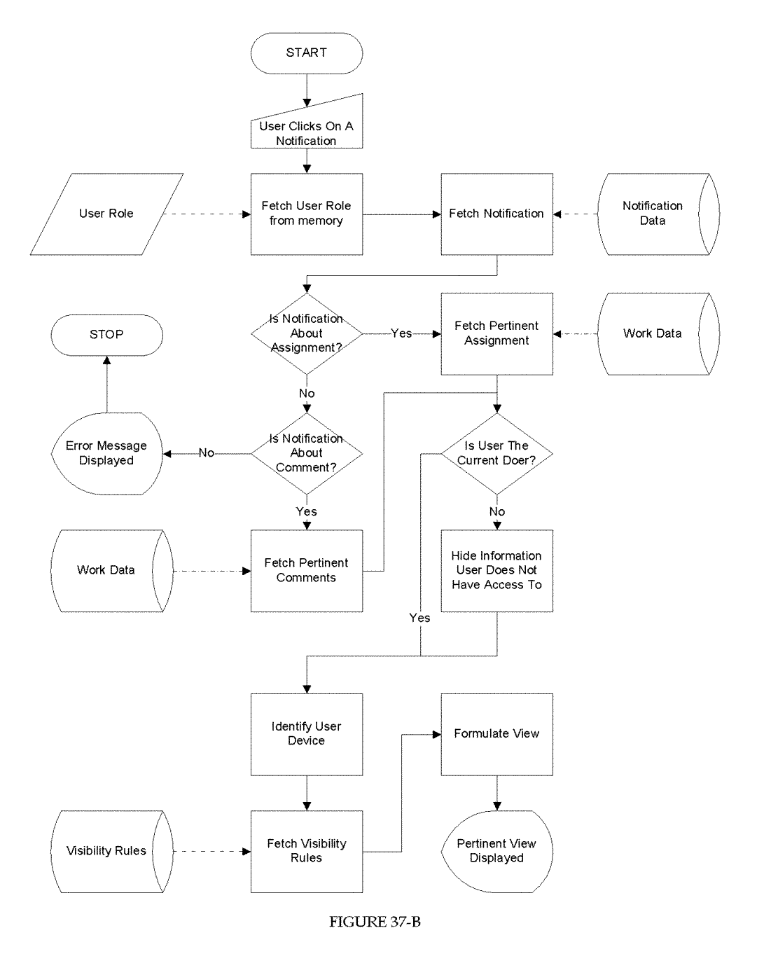

As described in foregoing sections of this document, the Serving System is to notify pertinent individuals when assignments are made, retracted, or when comments are added. FIG. 37-A illustrates the process flow of the ‘Notify’ step in FIG. 34, FIG. 35, and FIG. 36, respectively. When a phone notification needs to he sent, the Serving System is to fetch phone data from the ‘Phone’ table that contains data fields as described below:

Phone

| | |
|---|---|
| ID | Unique identifier of a phone record. |
| Person ID | The ID of a person who is to be notified via the phone identified in the record. |
| | The values in this field are to be sourced from the ID field in the Person table. |
| Device ID | Unique identifier of the phone. The value is to be sourced from the physical |
| | device. |
| Token | Unique token to be used during notification. The value is to be sourced from |
| | the physical device. |

Once pertinent phone data are available, the Serving System is to formulate the message and then send the message to the phone using the combination of the Device ID and the Token as unique identifier to locate the phone destined to receive the message. When an email notification needs to be sent, the Serving System is to fetch pertinent email address from the ‘Person’ table and then send the message to the email address retrieved. Upon receiving an acknowledgement from the targeted phone or email server, the Serving System is to store the notification in the ‘Notification’ table that contains data fields as described below:

Notification

| | |
|---|---|
| ID | Unique identifier of a notification record. |
| Type | The type of notification. Possible values are ‘Email’ or ‘Phone’. |
| Assignment ID | The ID of the assignment that necessitates the notification. The values in |
| | this field are to be sourced from the ID field in the Assignment table. |
| Activity ID | The ID of the activity associated with the assignment. The values in this |
| | field are to be sourced from the ID field in the Activity table. |
| Message ID | The ID of the message sent. |
| Sent Timestamp | The timestamp when the message was sent. |
| Acknowledgement | The timestamp when the acknowledgement was received from the phone |
| Timestamp | or email server. |

Examples of notifications of retracted assignment, new assignment, or new comment on smart phones are shown in FIG. 9, FIG. 11, and FIG. 14, respectively. FIG. 37-B illustrates the process flow when a user clicks on a notification. Upon user clicking on a notification, the Serving System is to fetch user role from user device memory for later processing. After fetching user role, the Serving System is to fetch pertinent notification from the ‘Notification’ table to ascertain what the notification pertains to. If the notification pertains to either a new assignment or a retracted assignment, the Serving System is to fetch the pertinent assignment from the ‘Assignment’ table. If the notification pertains to a new comment, the Serving System is to fetch the pertinent comments from the ‘Assignment Comment’ table. After pertinent data are available, the Serving System is to use the user role and assignment data to determine what data and features the user is authorized to access based on Visibility Rules. For example, a prior assignee is not authorized to access the current assignee, the ‘Comment’ button, or the ‘Attach’ button as shown in FIG. 10 whereas the current assignee, i.e., Doer, is able to see the current assignee, the ‘Comment’ button, and the ‘Attach’ button as shown in FIG. 12.

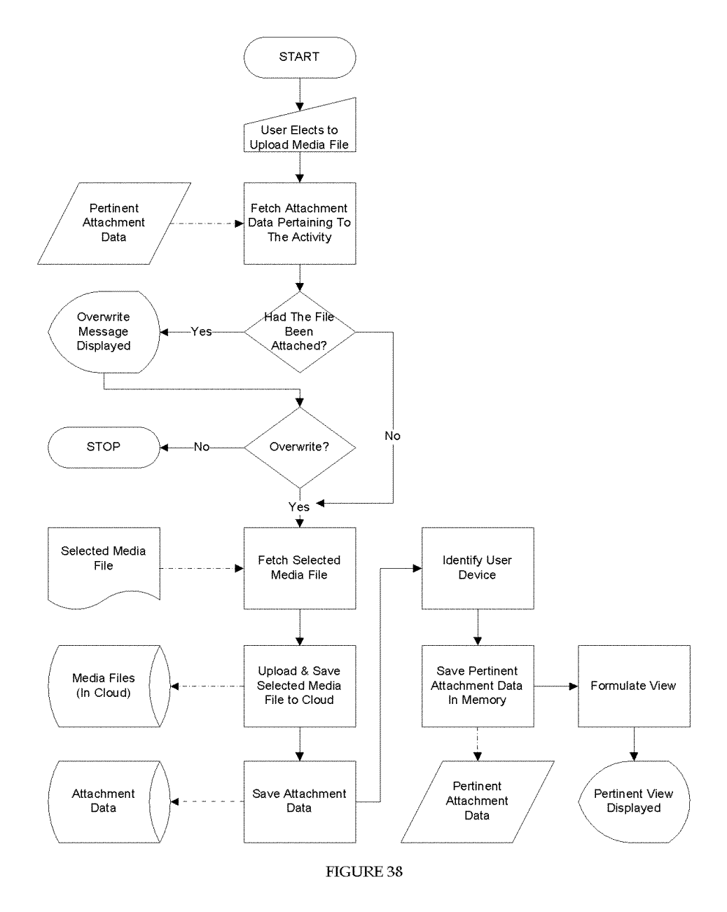

FIG. 38 illustrates the process flow when a user attaches a digital media file to an activity. An example of the view that enables digital media file attachment is shown in FIG. 15-A. The Action buttons and data fields that appear above the ‘Choose File’ button in FIG. 15-A are identical to the Action buttons and corresponding data fields that appear in a fourth tier view as shown in FIG. 5, which is described in a foregoing section of this document. Directly underneath the ‘Choose File’ button is the count of the digital media files already attached to the selected activity.

Data concerning the digital media files attached to an activity, as shown in FIG. 15-A, are displayed in a table with columns that fall into two categories: columns containing work data and columns containing action buttons. Columns in these two categories are further described as follows:

Columns Containing Work Data

| | |
|---|---|
| Name | The name of the digital media file. |
| Size | The size of the digital media file. |

Columns Containing Action Buttons

| | |
|---|---|
| View | Clicking on the ‘View’ button by a user is to cause the Serving System to display a view |
| [symbol] | that enables the user to either view the digital media file if it is viewable or listen to the |
| | file if it is an audio file. If the digital media file is not viewable and is not an audio file, |
| | the Serving System is to display ‘n/a’ in place of the ‘View’ button. Viewing digital media |
| | files is further described in a following section of this document. |
| Download | Clicking on the ‘Download’ button by a user is to cause the Serving System to enable the |
| [symbol] | user to download the digital media file to the user device. If a user device does not |
| | provide the capability to store files on the device, the Serving System is to hide this |
| | column from view as shown in FIG. 15-C, which is a file attachment view on a smart |
| | phone. Downloading digital media files is further described in a following section of this |
| | document. |
| Delete | Clicking on the ‘Delete’ button by a user is to cause the Serving System to delete the |
| [symbol] | digital media file in the Serving System. The Serving System is to enforce Visibility Rules |
| | to restrict access to the ‘Delete’ button. For example, two entries in the ‘Delete’ column in |
| | FIG. 15-A are displayed as ‘n/a’ because the user did not attach the two files and the |
| | pertinent Visibility Rule dictates that only individual who attached a file can delete the |
| | file from the Serving System. Likewise, the same Visibility Rule dictates that an entry in |
| | the ‘Delete’ column in FIG. 15-C is displayed as ‘n/a’ because the user did not attach |
| | the file. |

Upon user clicking on the ‘Choose File’ button, the Serving System is to display a file explorer popup to enable the user to traverse the file system on the user device to select a file for attachment. The result of a user having selected a file for attachment is shown in FIG. 15-B. The file name ‘NDA.pdf’ is displayed to the right of the ‘Choose File’ button. To the right of the selected file name is the ‘Upload’ button, which is shown as in FIG. 15-B.

The first step in FIG. 38 corresponds to a user clicking on the ‘Upload’ button to cause the Serving System to fetch pertinent data from the ‘Attachment’ table that contains data fields as described below:

Attachment

| | |
|---|---|
| ID | Unique identifier of an attachment record. |
| State | A flag to indicate the state of the digital media file, also known as ‘attachment’. |
| | Possible values are ‘Uploaded’ or ‘Deleted’. |
| Project ID | The ID of the project to which the attachment belongs. The values in this field |
| | are to be sourced from the ID field in the Project table. |
| Activity ID | The ID of the activity to which the attachment belongs. The values in this field |
| | are to be sourced from the ID field in the Activity table. |
| File Name | The name of the digital media file. |
| File Size | The size of the digital media file. |
| File Type | The type of the digital media file. Possible values include, but are not limited to, |
| | photos/images (JPGs, PNGs), PDFs, audios (MP3s), videos (MP4s, WEBMs), |
| | and text files (TXTs). |
| Last Updated By | The ID of the individual who acted on the attachment. The values in this field |
| | are to be sourced from the ID field in the Person table. |
| Last Updated | The timestamp when the attachment record was last updated. |
| timestamp | |

If the newly selected file is already attached to the selected activity, the Serving System is to prompt the user to confirm whether the file that exists in the Serving System should be overwritten. If the user elects to not overwrite the file, the attachment process is to terminate. If the newly selected file is not already attached to the selected activity or if the user elects to overwrite the file that exists in the Serving System, the Serving System is to fetch the selected digital media file from the user device. If the user device is a smart phone, the user could elect to attach a photo captured using the built in camera of the smart phone. After the digital media file is fetched from the user device, the Serving System is to store the file in a Cloud, which is a set of storage devices on the Internet that are separate and distinct from the Serving System disk storage. Upon successful completion of the file storage, the Serving System is to record the attachment in the ‘Attachment’ table with ‘Uploaded’ as the value of the ‘State’ data field. Afterwards, the process steps in FIG. 38 are similar to the corresponding steps shown in FIG. 31 as described in a foregoing section of this document, with the exception that the pertinent attachment data need to be saved in user device memory.

Upon user clicking on a ‘Delete’ button in an attachment view such as the one shown in FIG. 15-A, the Serving System is to remove the digital media file, displayed in the same row as the ‘Delete’ button, from the Cloud described in the preceding section of this document. After the digital media file is successfully removed from the Cloud, the Serving System is to update the pertinent record in the ‘Attachment’ table with ‘Deleted’ as the value of the ‘State’ data field.

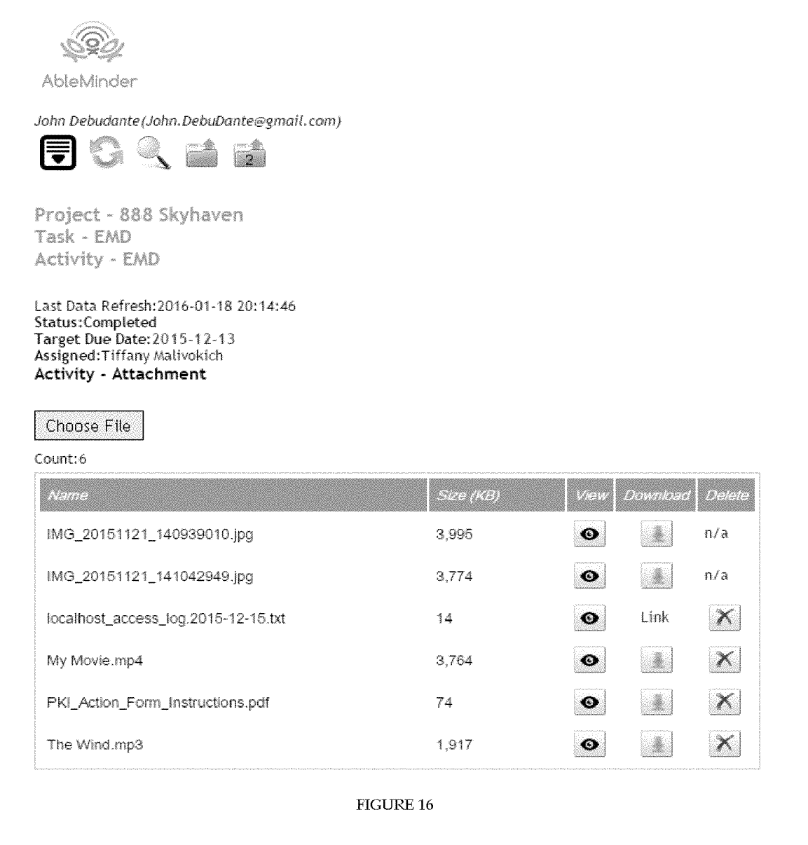

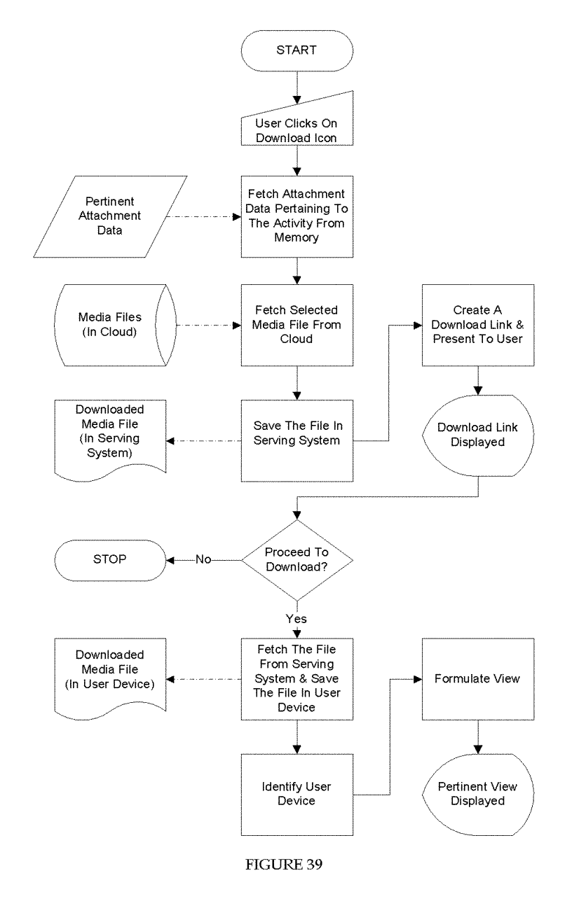

FIG. 39 illustrates the process flow when a user elects to download a digital media file attached to an activity. The process of file downloading starts with a user clicking on a ‘Download’ button in an attachment view such as the one shown in FIG. 15-A. Upon user clicking on a Download' button, the Serving System is to fetch the pertinent attachment data that were saved in user device memory during the attachment process depicted in FIG. 38. Once the pertinent attachment data are available, the Serving System is to download the selected digital media file from the Cloud, as described in the preceding section of this document, save the downloaded file on the local file system of the Serving System, and display a link to enable the user to download the file to the user device as shown in FIG. 16. If the user takes no action, the downloading process is to terminate. Otherwise, upon user clicking on the download link, the Serving System is to fetch the file from the Serving System and save the file in the local file system of the user device. Afterwards, the process steps in FIG. 39 are similar to the corresponding steps shown in FIG. 38 as described in the preceding section of this document with the exception that that the pertinent attachment data need not be saved in user device memory as the data already exist.

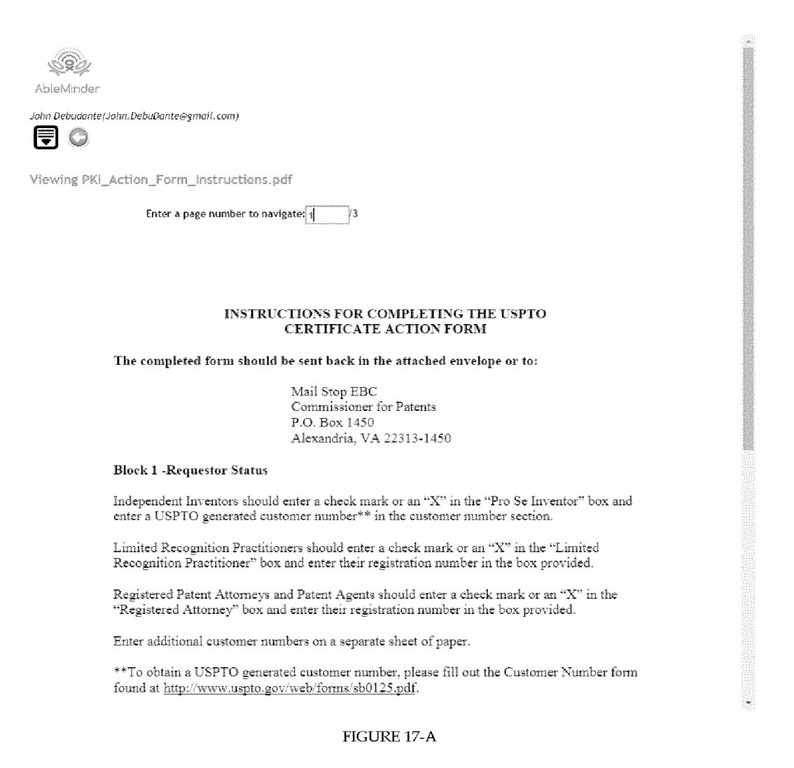

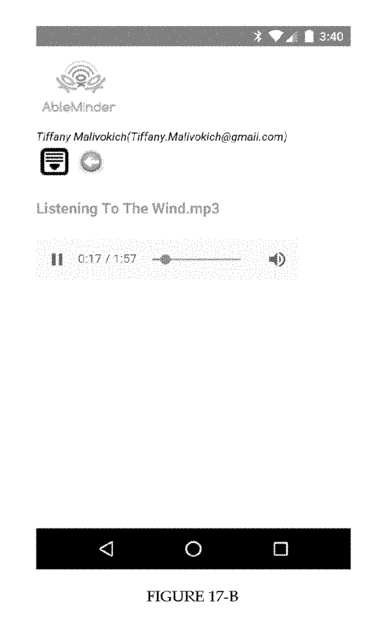

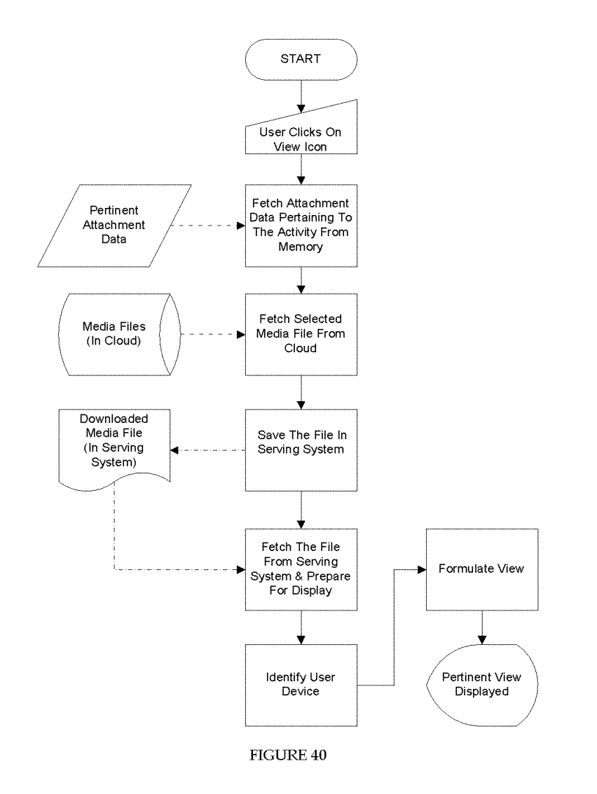

FIG. 40 illustrates the process flow when a user chooses to view or listen to a digital media file attached to an activity. The process of file viewing starts with a user clicking on a ‘View’ button in an attachment view such as the one shown in FIG. 15-A. Upon user clicking on a ‘View’ button, the Serving System is to fetch the pertinent attachment data that were saved in user device memory during the attachment process depicted in FIG. 38. Once the pertinent attachment data are available, the Serving System is to download the selected digital media file from the Cloud, as described in a foregoing section of this document, save the downloaded file on the local file system of the Serving System, and display the digital media file on the user device as shown in FIG. 17-A, which is a PDF file, or as shown in FIG. 17-B, which is an MP3 file. Afterwards, the process steps in FIG. 40 are identical to the corresponding steps shown in FIG. 39 as described in the preceding section of this document.

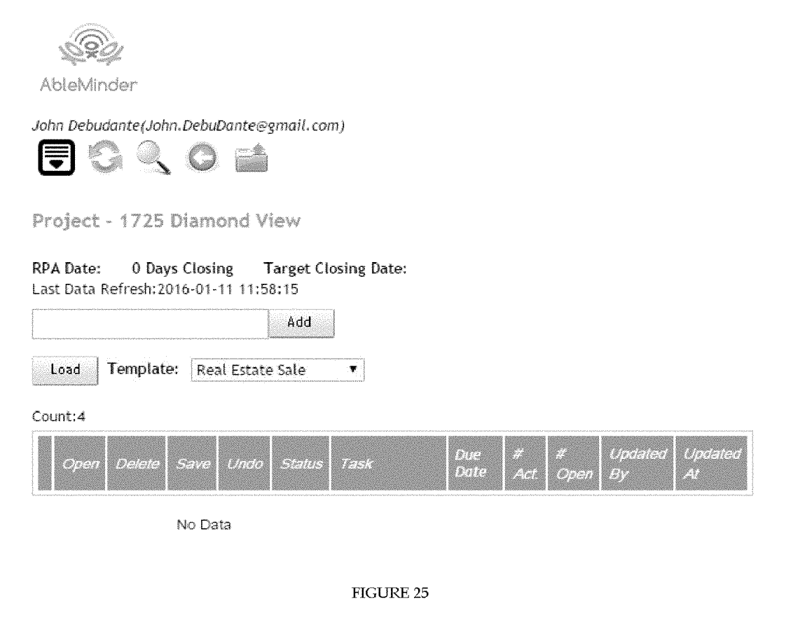

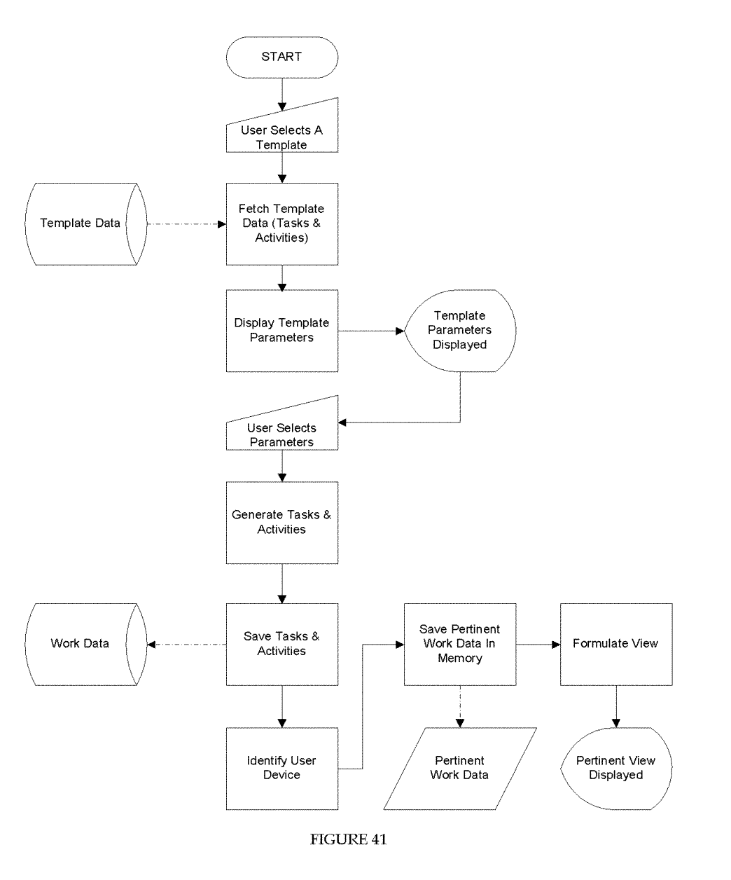

FIG. 41 illustrates the process flow when a pre-defined template is used to create tasks and activities in a project. The process of using pre-defined template to create tasks and activities starts with a user clicking on the ‘Load’ button in a second tier view as shown in FIG. 25. In the example shown in FIG. 25, the project does not have any task as evident by the ‘No Data’ verbiage under the data table heading. To the right of the ‘Load’ button is a drop down list of available pre-defined templates with the template ‘Real Estate Sale’ shown as the template selected by the user. Based on the applicable Visibility Rule, as described in a foregoing section of this document, the Serving System is to display the ‘Load’ button as well as the template drop down list only if the user is authorized.

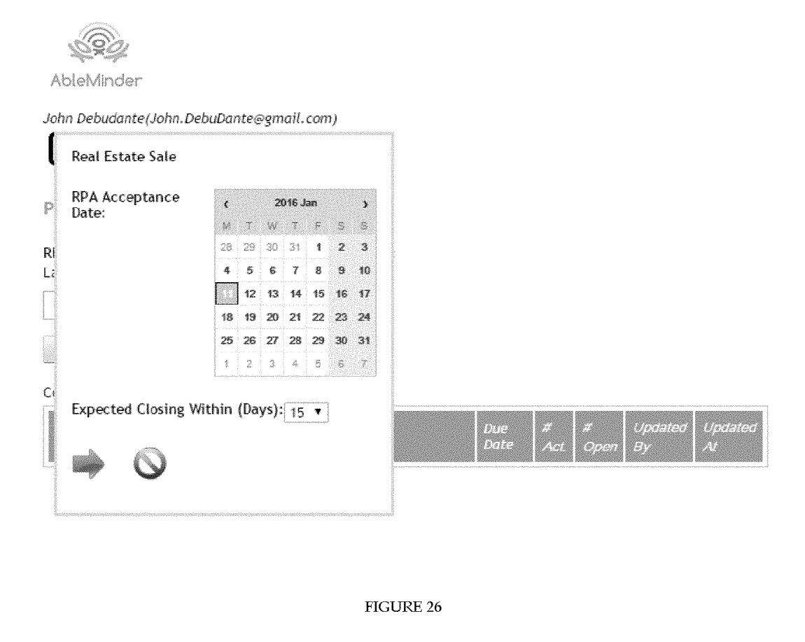

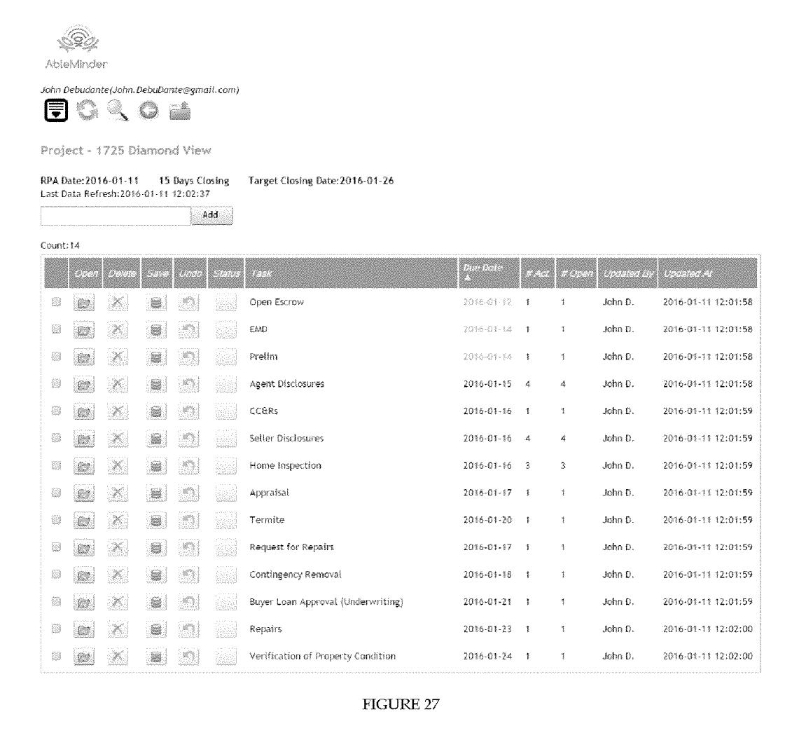

Upon user clicking on the ‘Load’ button, the Serving System is to fetch the data of the selected template, which contains the pre-defined tasks and activities. Depending on the selected template, the Serving System is to display pertinent template parameters that control how the tasks and activities should be created. As an example, FIG. 26 shows a pop up where two parameters are displayed for the user to select: RPA Acceptance Date (The Date the Real estate Purchase Agreement is ratified) and Expected Duration To Closing. Once the user selects the RPA Acceptance Date and Expected Duration To Closing, the Serving System is to create the tasks as well as activities as defined in the selected template, and then save the data in disk storage. Afterwards, the process steps in FIG. 41 are identical to the corresponding steps shown in FIG. 33 as described in a foregoing section of this document. FIG. 27 shows the resulted second tier view after the Serving System created the tasks and activities based on the user selections of Jan. 11, 2016 as the RPA Date and 15 days as the Expected Duration To Closing. In the example shown in FIG. 27, the Target Closing Date is calculated by the Serving System to be Jan. 26, 2016 (i.e., RPA Date +15 Days).

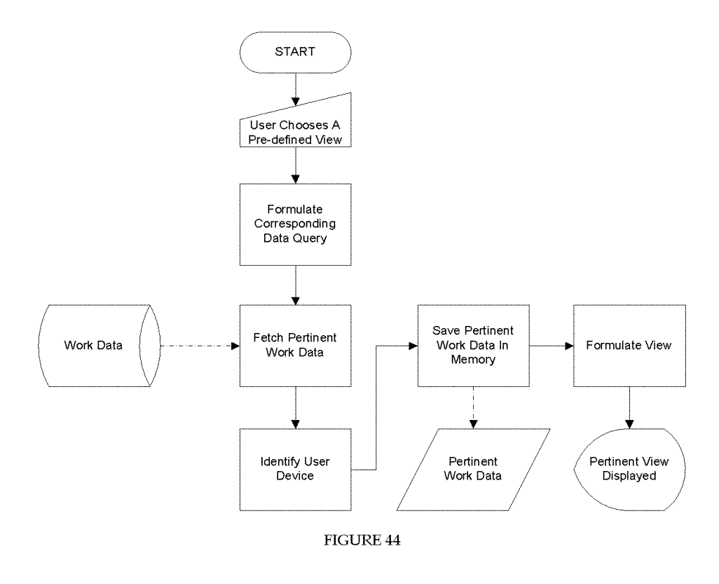

FIG. 44 illustrates the process flow when a user chooses a pre-defined view in the Menu. An example of the available pre-defined views is shown in FIG. 22. The available menu items as shown in FIG. 22 are merely examples given that the potential of adding other pre-defined views is limitless.

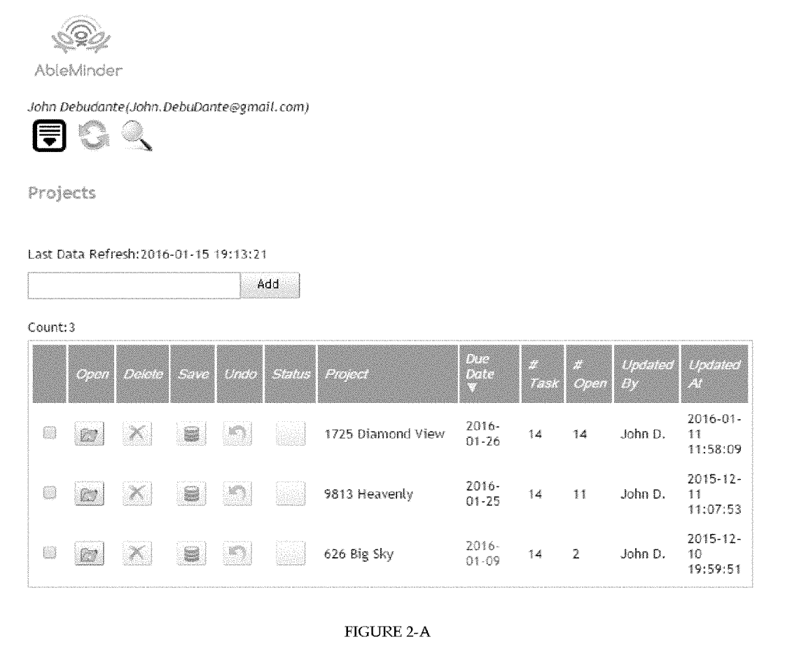

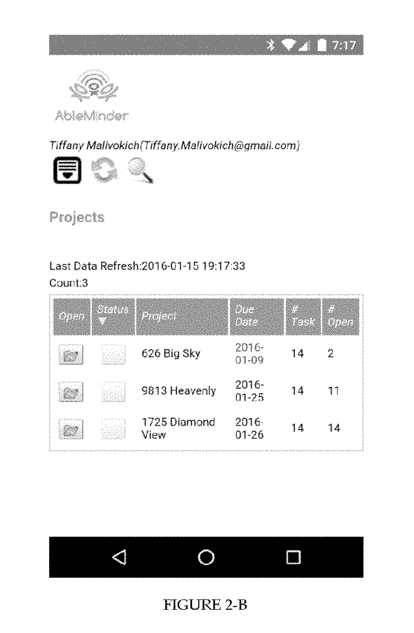

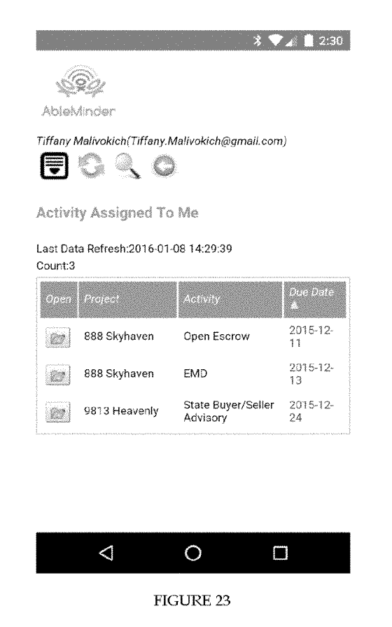

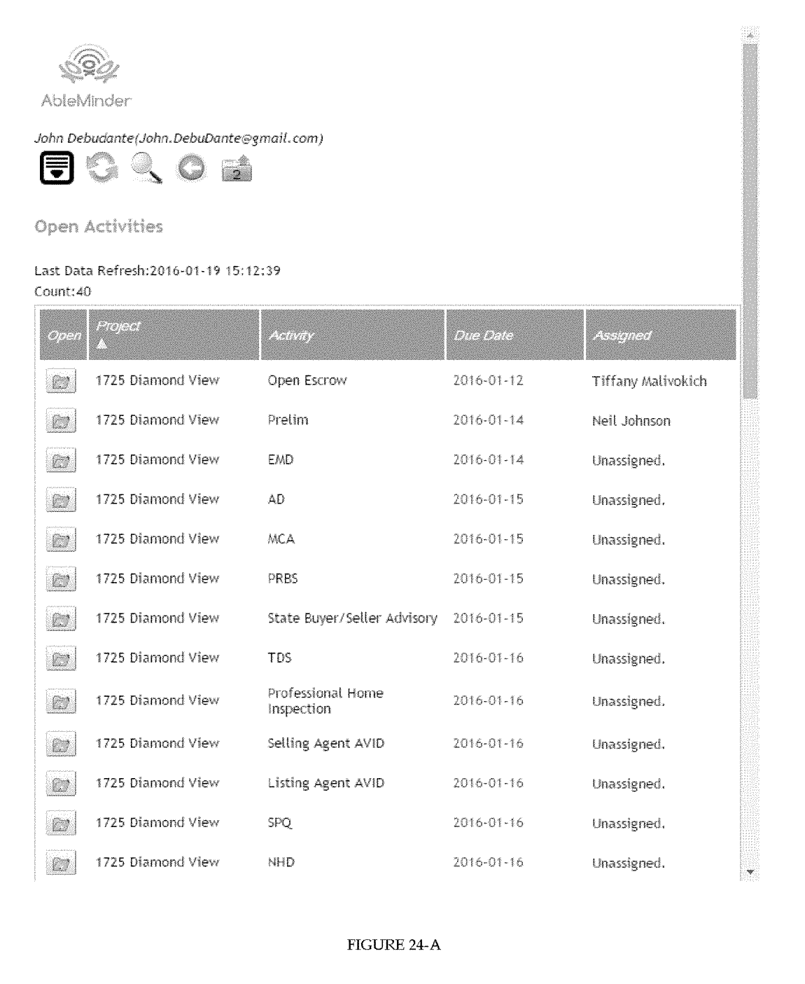

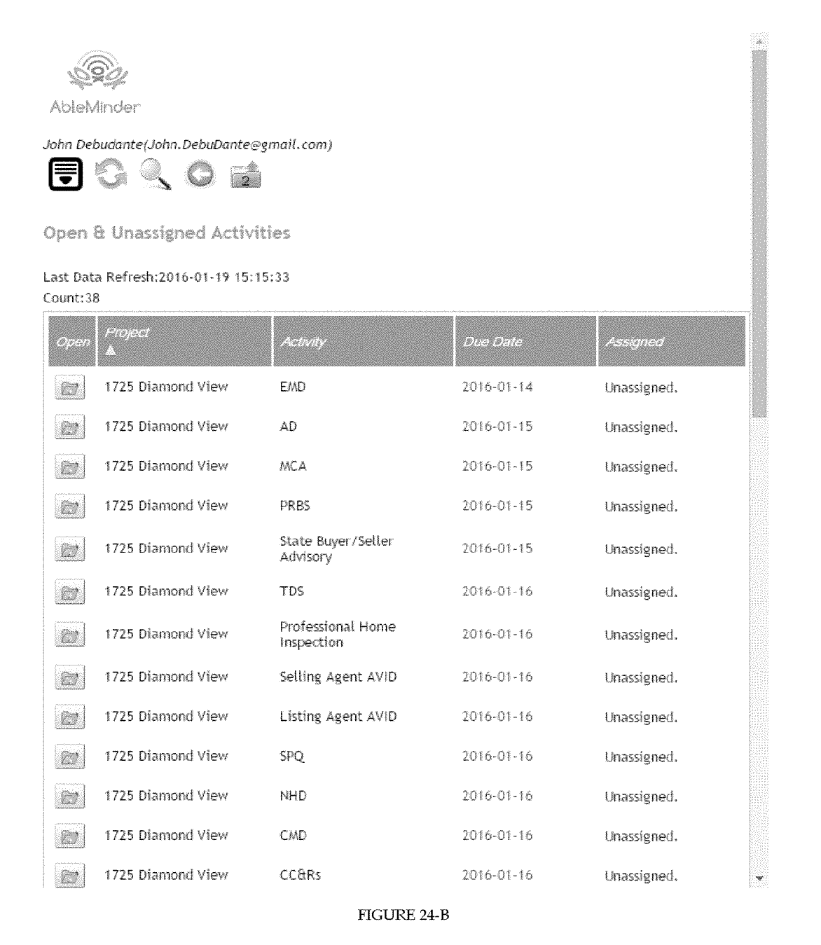

The process of displaying a pre-defined view starts by user selecting a pre-defined view from the Menu. Upon user selecting a pre-defined view, the Serving System is to formulate the corresponding database query and then fetch the necessary work data from the pertinent tables such as ‘Project’, ‘Task’, ‘Activity’, and ‘Assignment’ located in disk storage. Afterwards, the process steps in FIG. 44 are identical to the corresponding steps shown in FIG. 33 as described in a foregoing section of this document. Examples of the available pre-defined views are shown in the accompanying figures as listed below:

| | |
|---|---|
| All Projects | FIG. 1-A (Desktop Computer) & |
| | FIG. 1-B (Smart Phone) |
| Open Projects | FIG. 2-A (Desktop Computer) & |
| | FIG. 2-B (Smart Phone) |
| Activities Assigned To Me | FIG. 23 (Smart Phone) |
| Open Activities | FIG. 24-A (Desktop Computer) |
| Open & Unassigned Activities | FIG. 24-B (Desktop Computer) |

Clicking on an ‘Open’ button in the data table shown in any of the pre-defined views is to cause the Serving System to display the corresponding tier view. For example, clicking on an ‘Open’ button in FIG. 2-A is to cause the Serving System to display the second tier view of the project located in the same table row as the clicked ‘Open’ button. Clicking on an ‘Open’ button in FIG. 24-A is to cause the Serving System to display the fourth tier view of the activity located in the same table row as the clicked ‘Open’ button.

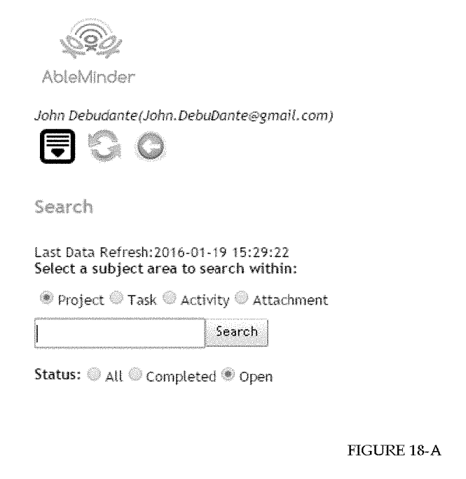

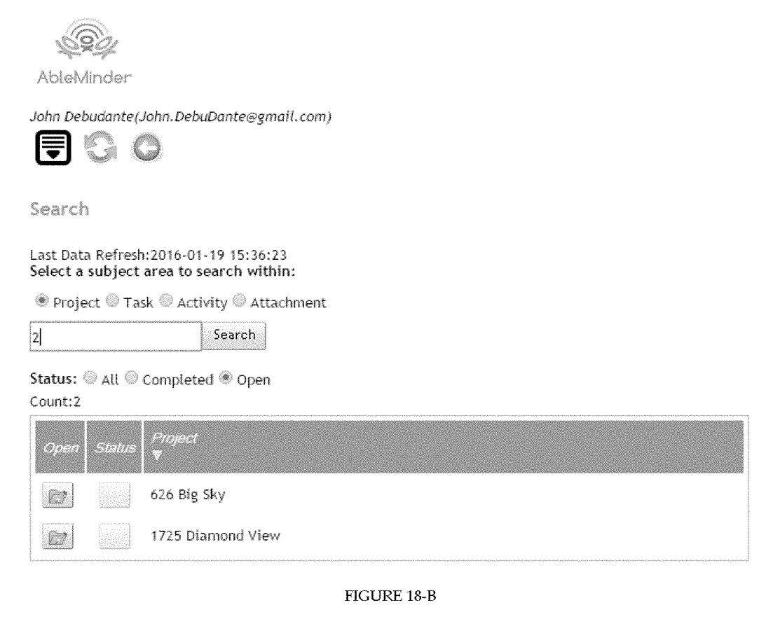

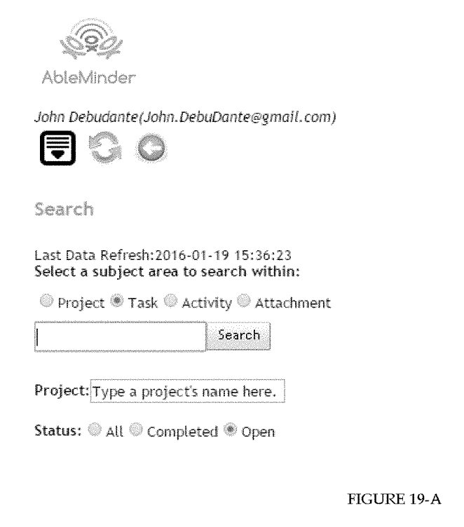

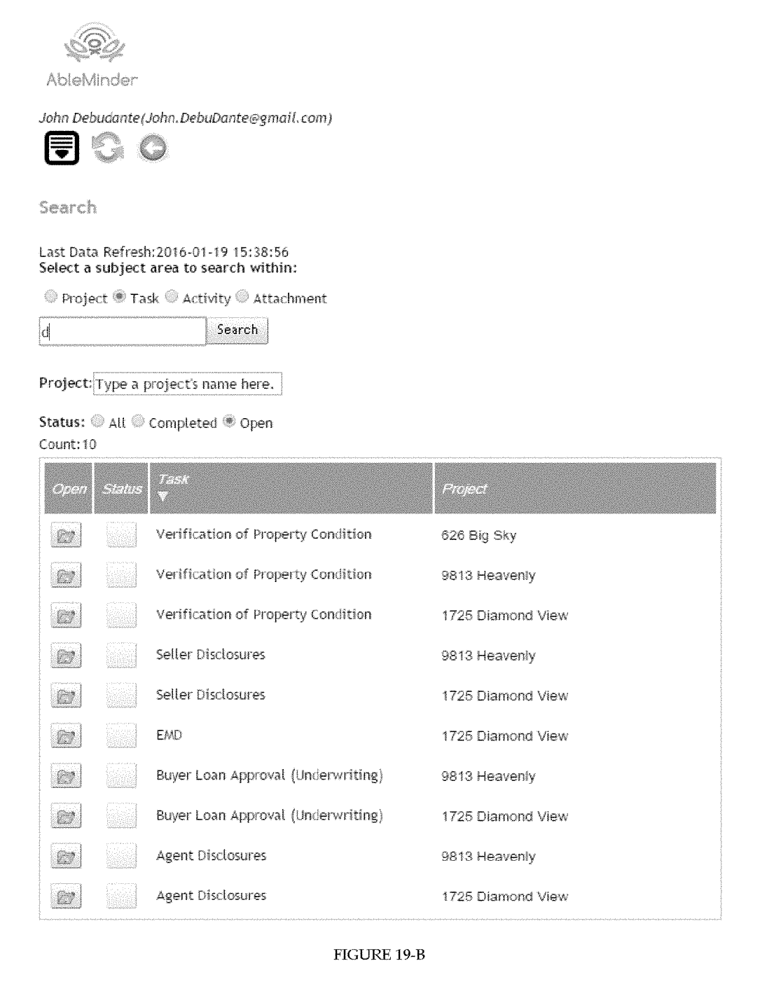

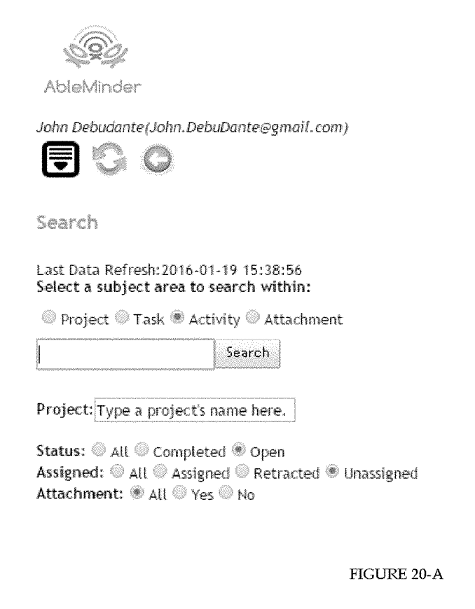

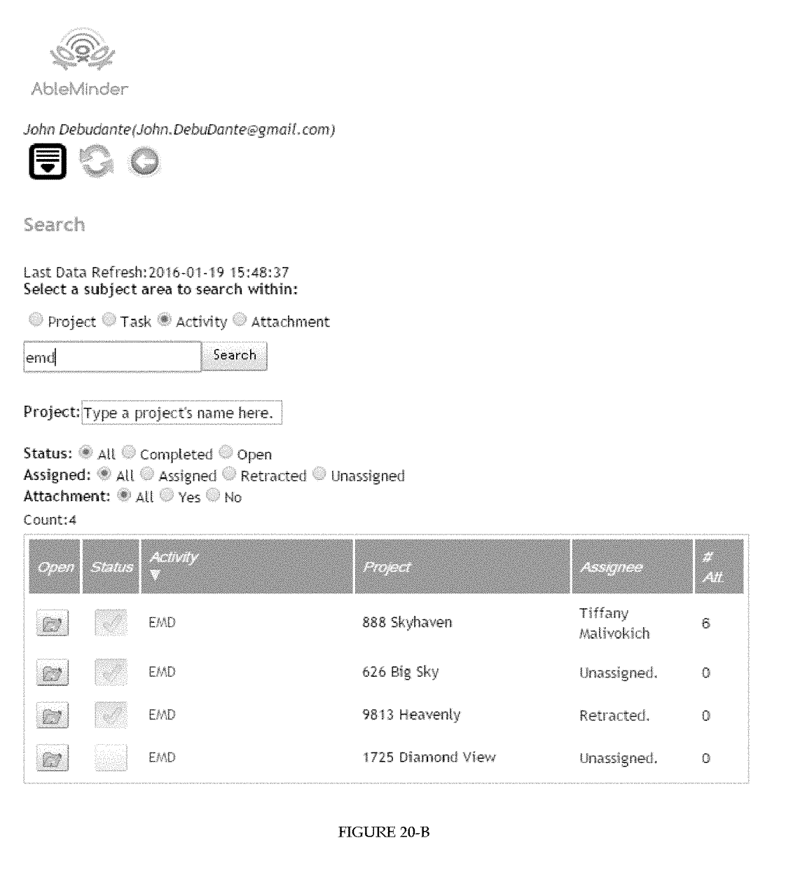

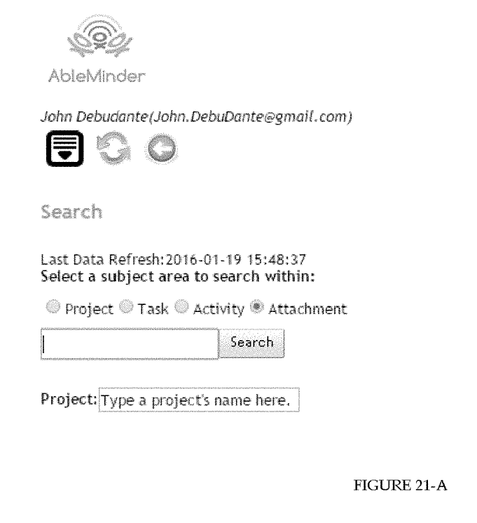

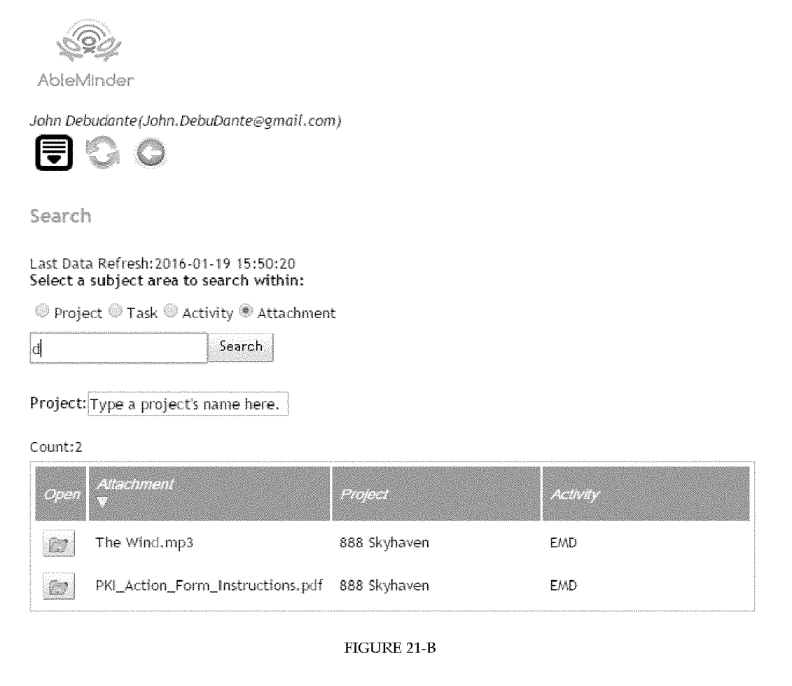

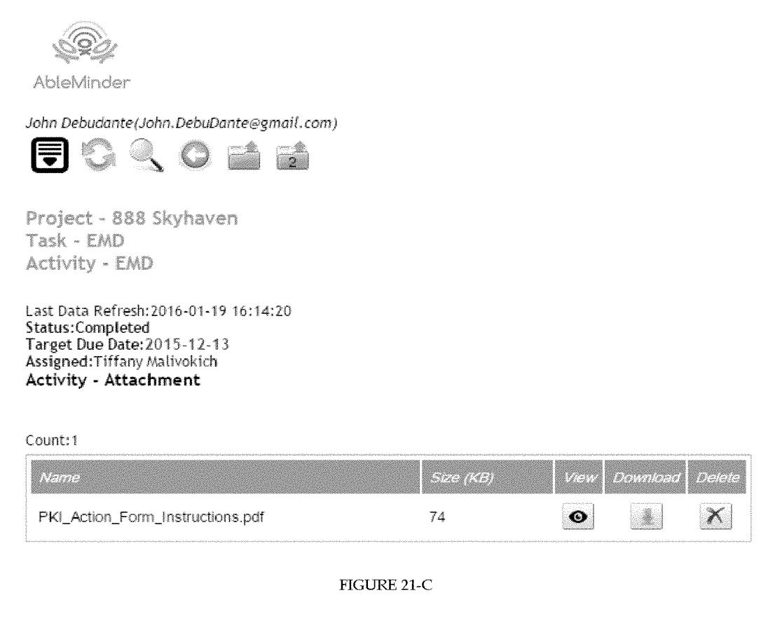

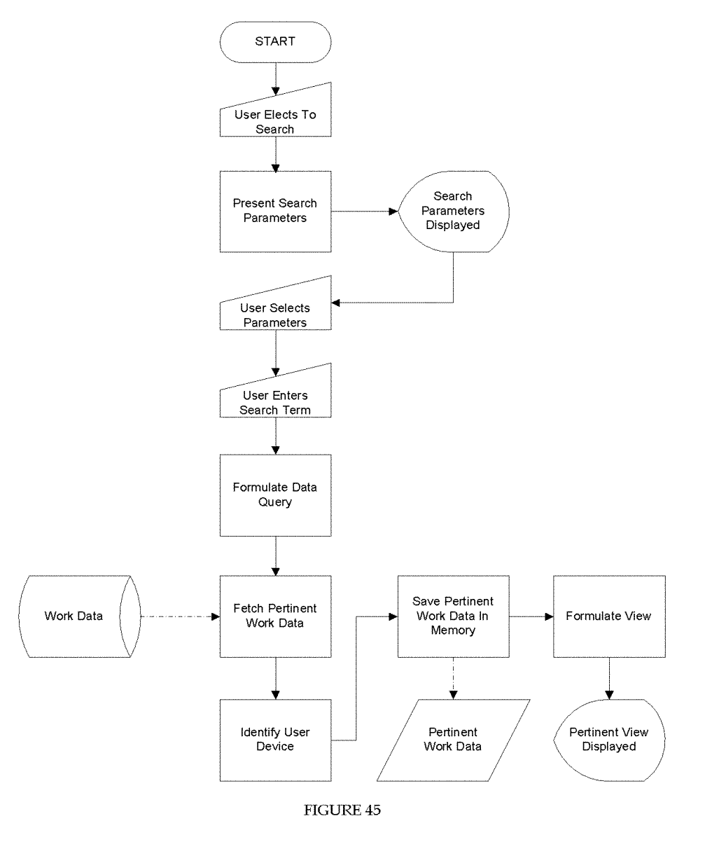

FIG. 45 illustrates the process flow when a user chooses to search the data stored in the Serving System. The process of searching data starts by user clicking on the ‘Search’ button as seen in many accompanying figures. Upon user clicking on the ‘Search’ button, the Serving System is to display a view, as shown in FIG. 18-A, that enables the user to select or enter pertinent parameters to control the search. By clicking on the radio buttons labeled ‘Project’, ‘Task’, ‘Activity’, or ‘Attachment’, a user can cause the Serving System to display parameters pertaining to the respective search as shown in the following accompanying figures:

| | |
|---|---|
| Project Search | FIG. 18-A (Desktop Computer) |
| Task Search | FIG. 19-A (Desktop Computer) |
| Activity Search | FIG. 20-A (Desktop Computer) |
| Attachment Search | FIG. 21-A (Desktop Computer) |

After a user enters a search term and select the pertinent search parameters, the Serving System is to formulate the necessary database query and fetch pertinent work data from the aforementioned tables located in disk storage. Afterwards, the process steps in FIG. 45 are identical to the corresponding steps shown in FIG. 33 as described in a foregoing section of this document. Examples of the search results displayed by the Serving System are shown in the following accompanying figures:

| | |
|---|---|
| Project Search | FIG. 18-B (Desktop Computer) |
| Task Search | FIG. 19-B (Desktop Computer) |
| Activity Search | FIG. 20-B (Desktop Computer) |
| Attachment Search | FIG. 21-B (Desktop Computer) |

While it is not easy to visualize due to the fact that all colors in the accompanying figures have been converted to gray scale, it is worth noting that the search term is highlighted in a different font color in each search result shown.

Clicking on an ‘Open’ button in the data table shown in any search result is to cause the Serving System to display the corresponding tier view. For example, clicking on an ‘Open’ button in FIG. 18-B is to cause the Serving System to display the second tier view of the project located in the same table row as the clicked ‘Open’ button. Clicking on an ‘Open’ button in FIG. 19-B is to cause the Serving System to display the third tier view of the task located in the same table row as the clicked ‘Open’ button. Clicking on an ‘Open’ button in FIG. 20-B is to cause the Serving System to display the fourth tier view of the activity located in the same table row as the clicked ‘Open’ button. Clicking on an ‘Open’ button in FIG. 21-B is to cause the Serving System to display the attachment view of the activity located in the same table row as the clicked ‘Open’ button. In contrast to the attachment view shown in FIG. 15-A, the ‘Choose File’ button is not visible in the attachment view as shown in FIG. 21-C, which is displayed as a result of user clicking on the pertinent ‘Open’ button in FIG. 21-B.

1. A Serving System comprising:
one or more computers, containing the program capable of delivering hierarchical work related data to user devices and receiving data from user devices as described in the methods identified in the claims that follow, in conjunction with pertinent storage devices, necessary support peripherals, networking devices, and networking infrastructure.

2. A computer implemented method comprising:
receiving and displaying, at a user device, a four-tier, hierarchical, tabular views of projects, tasks, and activities whereby the top tier view presents one or more projects belonging to the organization the user logs in under, the second tier view presents the tasks within a selected project, the third tier view presents the activities within a selected task, and the fourth tier view presents the data pertinent to a given activity;
displaying a button in any given row to enable the transition from a higher tier view to a lower tier view;
storing in Serving System the data of each project, task, or activity that, respectively, consists of a unique identifier, name, comment, status, due date, owner, last updated by, and last updated timestamp;
displaying data on any user device which can be a smart phone, tablet, laptop, desktop computer, or any device capable of rendering data received via electronic networks.
making available a mechanism for users to sign in whereas user identities are authenticated based on one or more appropriate algorithms prior to displaying data.

3. The method of claim 2, further comprising:
serving the second tier view with data from Serving System whereby a unique project identifier is used to associate a project to its tasks;
serving the third tier view with data from Serving System whereby a unique task identifier is used to associate a task to its activities.
serving the fourth tier view with data from Serving System whereby a unique activity identifier is used to identify an activity.

4. The method of claim 3, wherein determining a project identifier comprises:
sending a unique project name from a user device to Serving System;
receiving, from Serving System, a unique project identifier, based on an algorithm that guarantees uniqueness.

5. The method of claim 3, wherein determining a task identifier comprises:
sending a unique task name from a user device to Serving System;
receiving, from Serving System, a unique task identifier, based on an algorithm that guarantees uniqueness.

6. The method of claim 3, wherein determining an activity identifier comprises:
sending a unique activity name from a user device to Serving System;
receiving, from Serving System, a unique activity identifier, based on an algorithm that guarantees uniqueness.

7. The method of claim 2, further comprising:
enabling the user to add, update, or delete any project, task, or activity after displaying any project, task, or activity on a user device;
enabling the Owner of an activity to assign or retract a previous assignment. An assignment necessitates the assignee, termed ‘Doer’, to take pertinent action in order to complete the activity. A retraction of a previous assignment relieves the Doer from the obligation of completing the activity;
enabling the Owner and Doer of an activity to exchange information by adding comments to the activity;
preventing the prior assignee of a retracted assignment from accessing data pertaining to the assignments, comments, or attachments of the activity.

8. The method of claim 2, further comprising:
displaying past due projects, tasks, or activities in a font color that draws attention of users viewing the projects, tasks, or activities;
displaying projects, tasks, or activities that will become due within a configurable time period, termed ‘Caution Period’, in a font color that draws attention of users viewing the projects, tasks, or activities;
enabling the configuration of Caution Time Period by authorized Administrators of Serving System.

9. The method of claim 2, further comprising:
displaying any project, task, or activity, based on the visibility defined in the pertinent Visibility Rules, managed by Owner of a given project, stored within Serving System;
enabling the additions, updates, or deletions of Visibility Rules, by Owners of individual projects or Administrators of Serving System.

10. The method of claim 2, further comprising:
enabling Owners of projects to add Viewers of projects, tasks, or activities, via user devices, whereby the added Viewers are then granted rights to view the pertinent projects, tasks, or activities;
enabling Owners of projects to add or update email address, mobile phone number, or both of each Viewer via user devices such that the data are stored within Serving System;
enabling Owners of projects to remove Viewers of projects, tasks, or activities, via user devices, whereby the removed Viewers are then denied rights to view the pertinent projects, tasks, or activities;
enabling Owners of projects to remove email address, mobile phone number, or both of each Viewer via user devices such that the data are purged from Serving System;
notifying authorized users, via emails or text messages, regarding additions, updates, or deletions made to projects, tasks, or activities whereby pertinent projects, tasks, or activities can be viewed by clicking on a button or link embedded in each notification;
enabling Viewers to opt in or opt out of notifications.

11. The method of claim 2, further comprising:
enabling the addition of tasks and activities by generating the tasks and activities based on any pre-defined template, as chosen by Owner of a given project, stored in Serving System;
enabling the additions, updates, or deletions of templates that are general purpose, catered to an industry, or tailored to an organization, by authorized users of the method or Administrators of Serving System.

12. The method of claim 2, further comprising:
filtering the data displayed on user devices based on Archiving Rules, managed by Owners of individual projects, stored within Serving System;
enabling the additions, updates, or deletions of Archiving Rules, by Owners of individual projects or Administrators of Serving System;
enabling the inclusion of exceptions in Archiving Rules whereby individual projects on the exception list could be displayed even though the projects would be filtered out given a pertinent Archiving Rule.

13. The method of claim 2, further comprising:
automatically closing a session of App usage on any user device, with a notification to the user on the user device, if the user is deemed inactive by Serving System using a pertinent algorithm;
displaying a Menu to:
enable the viewing of data filtered by various predefined criteria, examples of such criteria include, but are not limited to, all projects, open projects, completed projects, activities assigned to an individual, open activities, open and unassigned activities;
enable the sign out of a user session;
displaying a ‘Refresh’ button in each applicable view such that clicking on the button by a user is to cause Serving System to fetch then display pertinent data to the user;
displaying a ‘Search’ button in each applicable view such that clicking on the button by a user is to cause Serving System to display a view that enables searching of the data stored within Serving System;
displaying a ‘Back’ button in each applicable view such that clicking on the button by a user is to cause Serving System to display the view that precedes the current view;
displaying an ‘Up’ button in each applicable tier view such that clicking on the button by a user is to cause Serving System to display the tier view one level higher than the current view displayed to the user;
displaying an ‘Up Two’ button in each applicable tier view such that clicking on the button by a user is to cause Serving System to display the tier view two levels higher than the current view displayed to the user.

14. The method of claim 7, further comprising:
enabling update of project, task, or activity name by making available to users an inline text editor;
enabling update of project, task, or activity status by user clicking on the status button;
enabling update of project, task, or activity due date by user clicking on the pertinent due date field;
displaying a date picker, when a due date field is clicked on, so the user can select a desired due date;
highlighting the updated fields with a background color sufficient to alert users that data had been edited and have not been saved.

15. The method of claim 7, further comprising:
sending one or more emails to the Doer of an activity when a given activity is assigned to the Doer;
sending one or more emails to a previously assigned Doer of an activity when the previous assignment is retracted;
sending one or more notifications to a smart phone, accessible by the Doer of an activity, when a given activity is assigned to the Doer. Clicking on a notification by a Doer is to cause Serving System to show the assigned activity to the Doer;
sending one or more notifications to a smart phone, accessible by the prior assignee of an activity, when the previous assignment is retracted. Clicking on a notification by a prior assignee is to cause Serving System to show the retracted assignment to the prior assignee;
sending one or more notifications to a smart phone, accessible by the Owner or Doer of an activity, respectively, when a comment is added to the activity. Clicking on a notification by an Owner or a Doer is to cause Serving System to show the newly added comment to the user.

16. The method of claim 7, further comprising:
enabling the attachment of digital media, including but not limited to, photos, captured using smart phones or digital cameras, images, PDFs, MP3s, MP4s, WEBMs, and text files, to any activity being updated by users via user devices;
storing the attached digital media in Serving System;
enabling the viewing or downloading of the attached digital media when pertinent activities are viewed on user devices.

17. The method of claim 7, further comprising:
displaying an undo button in the same row as the status, name, and due date of a project, task, or activity;
when an undo button is clicked, replacing the edited status, name, or due date with data that are stored in Serving System (‘Original Data’);
keeping Original Data in user session to eliminate the need to fetch data from Serving System.

18. The method of claim 7, further comprising:
enabling the sorting of projects, tasks, or activities by users clicking on the respective headings of fields such as status, name, or due date;
displaying the sorted project, task, or activity data without fetching data from Serving System.

19. The method of claim 13, further comprising:
enabling the searching of projects by project name and project status;
enabling the searching of tasks by task name, project name, and task status;
enabling the searching of activities by activity name, project name, activity status, assignment status, and whether attachments are present;
enabling the searching of attachments by attachment name and project name;
displaying search results in tabular view and showing the search term in a font color that highlights the search term when displaying search results;
enabling sorting of search results by users clicking on the respective headings of status, project, task, activity, assignee, attachment, or number of attachments fields;
displaying the sorted project, task, activity, or attachment data without retrieving data from Serving System;
enabling the viewing of project, task, activity, or attachment by users clicking on an ‘Open’ button in each pertinent tabular view of search result.
